(19) United States
(12) Patent Application Publication
(10) Pub. No.: US 2026/0288883 A1
(43) Pub. Date: Sep. 24, 2026

(54) SYSTEM

(71) Applicant: SoftBank Group Corp., Tokyo (JP)

(72) Inventor: Kosuke TAKAHASHI, Tokyo (JP)

(73) Assignee: SoftBank Group Corp., Tokyo (JP)

(21) Appl. No.: 19/561,933

(22) Filed: Mar. 10, 2026

(30) Foreign Application Priority Data
Mar. 19, 2025 (JP) 2025-044496

(51) Int. Cl. G06F 16/9535; G06F 18/24; G06N 3/0475; G06N 3/092

(52) U.S. Cl. CPC G06F 16/9535; G06F 18/24; G06N 3/0475; G06N 3/092

(57) ABSTRACT

A system includes a processor that is configured to acquire data by using a sensor device or a software module in order to collect information of a user, process the collected information by using a data analysis algorithm so as to identify an interest or a concern of the user, and generate a prompt sentence to be input to a generative AI model based on the identified interest or concern.

### CROSS-REFERENCE TO RELATED APPLICATION

This application is based on and claims priority under 35 USC 119 from Japanese Patent Application No. 2025-044496 filed on Mar. 19, 2025, the disclosure of which is incorporated by reference herein.

### BACKGROUND

### Technical Field

The present disclosure relates to a system

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information recommendation systems generally rely on predefined rules or simple statistical models to present information to users based on browsing history, search queries, or demographic attributes. Such systems often provide generic or only loosely personalized information, and they are not capable of dynamically formulating detailed instructions that fully exploit advanced generative AI models. In particular, existing techniques do not sufficiently address how to (i) systematically collect diverse user information through sensor devices and software modules, (ii) accurately analyze that information to identify the user's specific interests and concerns, and (iii) transform those identified interests into effective prompt sentences suitable for input to a generative AI model. As a result, users may receive content that is not closely aligned with their current preferences or contextual needs, leading to reduced engagement and limited usefulness of the delivered information. Furthermore, even when generative AI models are available, there is no integrated mechanism that automatically converts the generated information into short-duration videos and delivers them efficiently to the user via common communication applications or information search tools.

### SUMMARY

In order to solve the above-described problems, the invention provides a system comprising a processor, wherein the processor is configured to acquire data by using a sensor device or a software module in order to collect information of a user, process the collected information by using a data analysis algorithm so as to identify an interest or a concern of the user, and generate a prompt sentence to be input to a generative AI model based on the identified interest or concern. In one aspect, the processor is further configured to input the prompt sentence to the generative AI model and generate information adapted to the user, so that the generative AI model can produce highly personalized content that reflects the user's specific interests and concerns inferred from the collected data. In another aspect, the processor is further configured to automatically generate a short-duration video by using video editing software based on the generated information, and to provide the video to the user via an API of a communication application or an information search tool. By integrating user data acquisition, interest identification, prompt generation for generative AI, and automatic video creation and delivery, the system enables efficient, dynamic, and highly personalized provision of information to the user.

The term “sensor device” refers to any hardware device configured to detect or measure physical, environmental, or behavioral parameters related to a user and to output corresponding data signals, including but not limited to accelerometers, gyroscopes, GPS modules, cameras, microphones, wearable sensors, and biometric sensors.

The term “software module” refers to any software component, application, program, or code segment executed on a client device or on a server that is configured to collect, log, or transmit information related to a user, including but not limited to browser extensions, mobile applications, background services, and application programming interfaces.

The term “data analysis algorithm” refers to any computational procedure or set of procedures, including rule-based logic, statistical methods, machine learning models, or natural language processing techniques, that is configured to process collected data and to extract patterns, features, or inferences from the data.

The term “information of a user” refers to any data that is associated with a specific user or a user account, including but not limited to browsing history, search queries, application usage, location information, sensor readings, social media posts, and profile attributes, to the extent such data is available and permitted to be used.

The term “interest or concern of the user” refers to a topic, category, preference, need, or area of attention that characterizes what the user is likely to find relevant, useful, or engaging, and that is inferred from the collected user information by the data analysis algorithm.

The term “prompt sentence” refers to a text string, which may comprise one or more sentences or phrases, that is generated based on the identified interest or concern of the user and that is formatted so as to be suitable for input to a generative AI model as a prompt.

The term “generative AI model” refers to any artificial intelligence model configured to generate content, such as text, images, audio, or video, in response to input data or prompts, including but not limited to large language models, text-to-image models, and multimodal generative models.

The term “information adapted to the user” refers to content generated by the generative AI model that is customized or personalized based on the user's identified interests or concerns, such that the content is more relevant or tailored to that specific user compared to generic content.

The term “video editing software” refers to any software tool, library, or engine configured to compose, edit, or render video content, including functions for combining images, text, audio, and motion effects into a video file of a specified duration.

The term “short-duration video” refers to a video content item having a relatively brief playback time suitable for quick consumption, typically on the order of several seconds to a few tens of seconds, including but not limited to videos of approximately 30 seconds in length.

The term “communication application” refers to any software application or service that enables electronic messaging or communication between users or between a server and a user, including but not limited to messenger applications, chat applications, email clients, and social networking applications.

The term “information search tool” refers to any application, service, or interface configured to perform searches over information resources, including but not limited to web search engines, in-application search functions, and digital assistants that provide search results or information responses.

The term “API” refers to an application programming interface that defines a set of functions, protocols, or endpoints through which software components, including the processor of the system and external communication applications or information search tools, can exchange data or invoke services.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

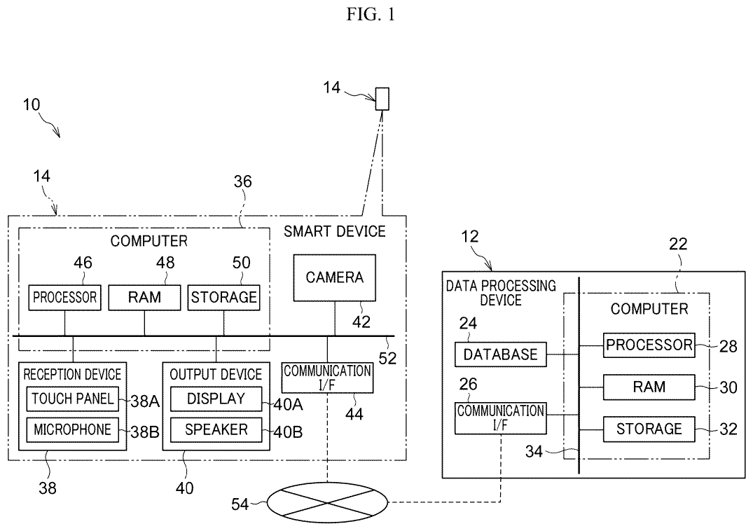

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

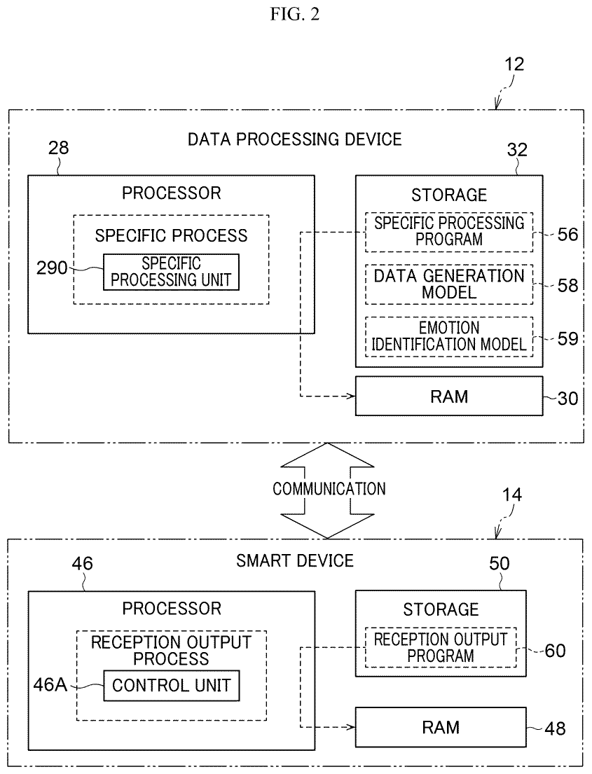

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content recommendation and media delivery systems typically rely on static rules or simple statistical models to select existing content items, such as pre-produced videos or articles, based on coarse user categories. These systems generally do not construct fine-grained user profiles from heterogeneous user data in real time, and therefore fail to generate content that is deeply personalized to a specific user's current interests, context, and interaction history. As a result, users are often presented with information that is only loosely relevant to their actual preferences, leading to low engagement and inefficient use of computing and network resources.

Further, known systems that employ generative AI models frequently treat the models as black-box text generators, issuing generic prompt sentences that are not systematically adapted to user feedback or viewing behavior. In such systems, the prompt engineering logic is static, and cannot automatically tune the content scope, style, and structure based on how users actually consume generated content. This leads to redundant or unsuitable outputs, unnecessary computation on generative AI infrastructures, and additional server-side processing to post-filter or discard generated results.

In addition, existing architectures often separate recommendation logic, generative AI invocation, and media rendering into loosely coupled subsystems without a unified control flow. This fragmentation makes it difficult for the computing system to optimize end-to-end performance for short-form video generation and delivery. For example, there is no integrated mechanism by which a processor automatically converts user-level textual recommendations into structured, scene-based video scenarios, incorporates control parameters such as video length and aspect ratio directly into the prompt sentences for a text-to-video generative AI model, and then feeds back viewing history to refine subsequent prompt sentences. Consequently, the utilization of hardware resources, including processors, accelerators, and networks, is suboptimal.

Moreover, many content delivery platforms lack explicit feedback loops connecting low-level viewing logs (such as completion rate, skipping behavior, and explicit user feedback) back into the core content generation algorithms. Although such logs may be stored for analytical purposes, they are not systematically linked to the generation of user-specific prompt sentences or to the dynamic adjustment of generative AI model inputs. This prevents the computing system from evolving its behavior over time in a data-driven manner, and results in slow convergence to user-preferred formats and topics.

Accordingly, there is a need for a computer-implemented system that integrates user data collection, user profile generation, dynamic prompt sentence construction, generative AI model invocation, scene-based short video generation, and feedback-driven adaptation into a unified processing pipeline. Such a system should improve the operation of the underlying computer technology by automatically structuring and refining prompt sentences for generative AI models based on machine-readable user profiles and interaction data, thus enhancing both personalization quality and computational efficiency in the generation and delivery of short-form video content.

The specific processing by the specific processing unit 290 of the data processing device 12 in Example 1 is realized by the following means.

The present invention provides a server comprising a processor configured to acquire, by using a sensor device or a software module, online activity information and location information of a user, analyze the acquired information to extract feature data representing preferences and interests of the user, generate a user profile based on the feature data, construct, based on the user profile, a first prompt sentence as text input for a generative AI model, input the first prompt sentence to the generative AI model, and obtain, from the generative AI model, personalized information in a text format, divide the personalized information into a plurality of scene units, generate a video scenario including visual content information and subtitle information corresponding to each of the plurality of scene units, and generate, based on the video scenario, a second prompt sentence for video generation, input the second prompt sentence as text input to a text-to-video type generative AI model and automatically generate short video data, store the generated short video data in an external storage device, transmit, via a communication network to a terminal device, notification data including identification information for accessing the short video data, acquire viewing history information and feedback information relating to the short video data from the terminal device, store the viewing history information and the feedback information in association with the user profile, and update generation conditions of the first prompt sentence and the second prompt sentence based on a result of the storing. This enables the server to implement a feedback-driven, end-to-end control loop that dynamically adapts prompt sentences and video generation parameters at the system level, thereby improving the operation of the underlying computer technology by producing more relevant, resource-efficient, and user-tailored short-form video content through coordinated processing of user data, generative AI model inputs, and media delivery.

The term “processor” refers to a hardware computing element, such as a central processing unit, a graphics processing unit, or a programmable logic device, that executes machine-readable instructions to perform data acquisition, analysis, generation, storage, and communication operations described in the present specification.

The term “online activity information” refers to digital data representing actions performed by a user in a networked environment, including but not limited to web browsing history, search queries, access logs, and interactions with network services or applications.

The term “location information” refers to data indicating a geographical position associated with a user or a user device, including but not limited to coordinates, region identifiers, or motion trajectories, which may be obtained from a positioning module or a communication network.

The term “sensor device” refers to a hardware component or a combination of hardware components that detects physical or environmental conditions and outputs digital data, including but not limited to positioning sensors, motion sensors, and communication interface modules.

The term “software module” refers to an executable program component, such as an application, an extension, a plug-in, or an application programming interface client, that operates on a computing device to collect, preprocess, or transmit data used by the system.

The term “feature data” refers to processed values or descriptors derived from raw input data, representing characteristics such as topics, preferences, interests, frequencies, or patterns associated with a user.

The term “user profile” refers to a structured data representation that aggregates and stores feature data associated with a user, including inferred preferences, interests, behavior patterns, and contextual attributes used for personalization.

The term “generative AI model” refers to an artificial intelligence model that receives input data, including a prompt sentence, and generates new content such as text, images, or audiovisual data, based on learned patterns from training data.

The term “prompt sentence” refers to a text-based input sequence that specifies instructions, constraints, or contextual information supplied to a generative AI model to control the nature, scope, and style of generated content.

The term “personalized information” refers to generated content in a text format that is tailored to a particular user based on the user profile, including but not limited to recommendations, summaries, tips, or explanations.

The term “scene unit” refers to a logical segment of content corresponding to a temporally or thematically distinct portion of a video, characterized by associated visual elements, textual elements, or both.

The term “video scenario” refers to a structured description of a video composed of a plurality of scene units, including, for each scene unit, visual content information, subtitle information, and optionally timing and style parameters.

The term “visual content information” refers to descriptive data specifying visual elements of a video scene, such as background, characters, objects, actions, compositions, or styles to be rendered or generated.

The term “subtitle information” refers to textual data associated with a video scene, including dialogue, captions, annotations, or explanatory text intended to be displayed in synchronization with the visual content.

The term “second prompt sentence for video generation” refers to a prompt sentence constructed from the video scenario and used as text input to a text-to-video type generative AI model to control the generation of video data.

The term “text-to-video type generative AI model” refers to a generative AI model that receives text-based input, including a prompt sentence, and produces video data representing a temporal sequence of visual frames, optionally with associated audio.

The term “short video data” refers to digital video content generated by the system having a limited duration, such as several seconds to a few minutes, suitable for brief consumption on a terminal device.

The term “external storage device” refers to a storage resource external to the processor, such as a local storage unit, a network-attached storage device, or a cloud-based storage service, configured to store video data and related information.

The term “communication network” refers to a wired or wireless communication infrastructure that enables data exchange between the server and one or more terminal devices, including local networks and wide-area networks.

The term “terminal device” refers to an endpoint computing device used by a user, such as a mobile device, a tablet device, a personal computer, or a display device, capable of receiving notifications, accessing video data, and providing feedback.

The term “notification data” refers to message data transmitted from the server to a terminal device, including information such as a title, a description, and identification information for accessing associated video data.

The term “identification information for accessing the short video data” refers to data that uniquely or specifically indicates the location or resource identifier of short video data within a storage system, such as a uniform resource locator, a resource identifier, or a token.

The term “viewing history information” refers to data representing how a user views video content, including but not limited to play events, pause events, completion rates, skipping behavior, timestamps, and duration of viewing.

The term “feedback information” refers to data explicitly or implicitly expressing user reactions to content, including but not limited to user ratings, likes, dislikes, comments, selection actions, or other interaction signals.

The term “generation conditions of the first prompt sentence and the second prompt sentence” refers to parameters, rules, or constraints used by the processor to construct the first prompt sentence and the second prompt sentence, including weighting of topics, selection of content types, style specifications, structural templates, and control parameters for video generation.

The term “control parameter” refers to a parameter associated with a scene unit or an entire video that influences how video content is generated or presented, including but not limited to video length, aspect ratio, expression style, and display text.

The term “expression style” refers to a specification of visual or aesthetic characteristics of generated video content, including but not limited to realism level, color schemes, animation type, and overall visual tone.

The term “application programming interface of a communication application or an information search tool” refers to a programmatic interface provided by a messaging application, a communication service, or an information retrieval service, through which the processor can transmit, retrieve, or manage content, notifications, or related data.

In one embodiment, a server cooperates with one or more terminals and a user to implement the system described in the claims. The server includes at least one processor, a main memory, a nonvolatile storage device, a network interface, and optionally one or more hardware accelerators such as graphics processing units. The terminal includes a processor, a memory, a display unit, an input unit, and a communication interface. The user operates the terminal and optionally a browser extension or an application to permit collection of online activity information and location information.

The server executes a plurality of software modules stored in the nonvolatile storage device and loaded into the main memory. These modules may include an operating system, a web server, a data collection module, a feature extraction module, a profile management module, a prompt construction module, a generative AI client module, a video scenario generation module, a text-to-video client module, a storage management module, a notification module, and a feedback processing module. The server uses a database management system, such as a relational database system, and a file or object storage system to store user profiles, prompt sentences, generated text, video scenarios, and short video data.

The server uses specific types of hardware and software to process data. For example, the server uses a central processing unit to execute general control logic and data manipulation instructions, and uses a graphics processing unit to perform matrix multiplication and convolution operations for neural network inference. The server uses a database system, such as a relational database management system, to store tables representing users, events, and generated content. The server uses a web server framework and an application framework to provide interfaces for browser extensions and terminal applications. The server interacts with a generative AI model deployed on a remote computing system or on the same computing infrastructure. The generative AI model may be implemented as a transformer-based neural network including an embedding layer, a plurality of multi-head self-attention layers, feed-forward layers, normalization layers, and output projection layers. The server communicates with this generative AI model through an application programming interface, using text-based prompt sentences.

The server obtains online activity information from a software module executed on a browser or an application on the terminal. The terminal executes, for example, a browser extension implemented as a script that intercepts or records identifiers of visited network resources, search query strings, timestamps, and referrer information. The terminal transmits the recorded activity information to the server through a secure communication protocol. The server also obtains social interaction events from software modules that call external service interfaces. For example, the server calls an application programming interface of a social networking service to obtain posts and reaction information associated with the user. In addition, the terminal executes an application that accesses a positioning service of an operating system to obtain location information, such as latitude, longitude, and a timestamp.

The terminal transmits this location information to the server in a structured format.

The server stores the received data in a database. The server uses a data structure in which each record includes a user identifier, a time stamp, a data type identifier, and a payload field.

The server separates the payload into normalized tables representing, for example, search events, social posts, and location samples. The server associates each record with the user identifier so that subsequent modules can access all information related to the user.

The server executes a feature extraction module to process this data. The server uses term frequency computation, n-gram extraction, and optional statistical or neural embedding techniques to convert text associated with queries and posts into numerical feature vectors.

The server also uses clustering or topic modeling algorithms to identify dominant topics in the online activity information. The server processes location information by calculating spatial clusters and identifying areas frequently visited by the user. The server aggregates these results to produce feature data that represent the user's interests and behavior patterns. The server stores this feature data in association with the user identifier.

The server generates a user profile as a structured representation that may include fields such as dominant topics, preferred content categories, time-of-day activity patterns, frequently visited regions, and content format preferences. The server represents the user profile, for example, as a set of key-value pairs stored in a relational table or as a serialized structure in an object storage system. The server updates the user profile when new feature data are calculated, thereby maintaining a current representation of the user's state.

The server constructs a first prompt sentence for a generative AI model based on the user profile. The server reads one or more fields from the user profile and inserts them into a prompt template. The server may incorporate explicit instructions regarding structure, length, and style of the desired output. For example, the server may generate a prompt sentence such as:

“Analyze the following user profile and generate a personalized daily briefing for this user. The briefing should include: (1) one outfit suggestion suitable for today's weather, (2) three main news headlines with one-sentence summaries, and (3) two short tips related to the user's main hobbies. Use concise and friendly language. User profile: [profile content].”

The server may generate other prompt sentences depending on the desired content. For example, the server may generate:

“Based on the user's recent search history about trail running and weekend hiking routes, generate a short description of a recommended hiking plan near the user's location, including clothing, equipment, and safety advice, written in simple language.”

The server transmits the constructed first prompt sentence to a generative AI model. The server may host the generative AI model locally using a hardware accelerator or may call a remote service. In a local configuration, the server stores the parameters of the generative AI model, such as weight matrices and bias vectors of a transformer network, in a storage device and loads them into memory at inference time. The server executes a neural network inference library to perform sequence encoding and decoding operations. The server encodes the prompt sentence as a sequence of token identifiers, applies embedding operations, propagates the embedded sequence through stacked self-attention and feed-forward layers with normalization and residual connections, and decodes an output token sequence corresponding to the personalized information in text form.

The server stores the resulting personalized information in a database. The server checks the format of the resulting text and parses it into logical segments. For instance, the server may identify sentence boundaries or marker phrases such as “Outfit suggestion:”, “News:”, and “Tips:”. The server defines these segments as scene units for a video.

The server constructs a video scenario from these scene units. The server associates each scene unit with visual content information and subtitle information. The server maintains a library of visual templates, each described by parameters such as background type, character presence, camera perspective, and animation behavior. The server selects an appropriate template based on the category of the scene unit. For example, the server may select a “person in an urban environment” template for an outfit suggestion segment, a “icon and text overlay” template for a news segment, and a “symbolic illustration” template for a hobby tips segment.

The server generates subtitle text by taking key sentences from the personalized information and shortening them to fit on a display in a limited time.

The server defines control parameters for each scene unit. The server may specify a duration for each scene, such as a few seconds per scene, an aspect ratio, such as vertical or horizontal orientation, an expression style, such as realistic, cartoon-like, or minimalist, and display text properties, such as font size and position. The server records this information in a structured scenario representation stored in memory or in a database.

The server constructs a second prompt sentence for a text-to-video generative AI model based on the video scenario. The server may include an overview of the desired video and detailed instructions per scene. For example, the server may generate a second prompt sentence such as:

“Generate a 30-second vertical video (1080x1920) that consists of 4 scenes: Scene 1 (intro): show a simple animated title card with the text ‘Your Personal Morning Briefing’. Scene 2 (outfit): show a person standing near an office building wearing the recommended outfit, with a text overlay ‘Today's outfit suggestion’. Scene 3 (news): show dynamic icons and short captions summarizing three main news headlines. Scene 4 (hobby tips): show quick visual icons and short captions illustrating two tips related to the user's main hobby. Use a clean, modern style with soft colors and readable captions.”

The server may also generate a second prompt sentence such as:

“Based on the following hiking plan, generate a 30-second vertical video that shows a user preparing hiking gear, checking the weather, walking along a mountain trail, and enjoying a scenic viewpoint. Overlay short captions with clothing recommendations, equipment items, and safety tips. Keep the style friendly and semi-realistic.”

The server inputs the second prompt sentence to a text-to-video generative AI model. The server may implement this model using a diffusion-based network architecture in which a latent representation of a video sequence is iteratively denoised under guidance from a text encoding. The server encodes the second prompt sentence using a text encoder component, such as a transformer-based encoder, and injects this encoding into a video generation network consisting of multiple three-dimensional convolution layers, attention mechanisms, and upsampling layers. The server uses time steps, noise levels, and guidance scales as control parameters for a denoising process. The server generates a sequence of frames that, when assembled and encoded, form the short video data.

The server may host this text-to-video generative AI model locally, using a graphics processing unit to accelerate the convolution and attention computations, or may call an external service through a network interface. In both cases, the server manages job submission and monitoring so that the server can determine when the short video data is available. The server receives the generated video, verifies its length, resolution, and format, and may convert the video using a media processing library to conform to the capabilities of target terminals.

The server stores the generated short video data in an external storage device. The external storage device may include a disk array, a network-attached storage appliance, or a remote object storage service. The server obtains identification information, such as a resource locator or an object identifier, corresponding to the stored video. The server records this identification information in a table associated with the user and the corresponding user profile.

The server constructs notification data including at least a text summary and the identification information for accessing the short video data. The server may include a title, an optional preview image, and metadata indicating the estimated viewing time. The server uses a notification module to call a push messaging service or an application programming interface of a communication application or an information search tool. The server transmits the notification data through a communication network to the terminal.

The terminal receives the notification data via its network interface and passes it to a notification subsystem of the operating system. The terminal displays a notification on a screen, indicating that a personalized short video is available. The user interacts with the terminal by selecting the notification. The terminal then opens a viewer component, such as a native application or a browser-based user interface. The terminal requests the short video data from the server or directly from the external storage device, using the identification information contained in the notification data. The terminal receives the short video data and decodes it using a hardware video decoder or a software media player implementation. The terminal renders the video frames on the display and, if present, outputs audio through a speaker.

The terminal records viewing history information and feedback information during and after playback. The terminal may record events such as playback start and end times, pause operations, seeking operations, skip actions, and whether the user completes viewing the video. The terminal may also present input elements such as “like,” “dislike,” or “not interested” buttons. The terminal transmits the recorded information to the server through a secured communication channel.

The server receives the viewing history information and feedback information and stores them in association with the user profile. The server computes aggregated metrics, such as completion rate, average watch time, and relative interest in different content sections. The server uses these metrics to update generation conditions for future prompt sentences. For example, the server may increase a weight associated with a certain topic in the user profile if videos containing that topic consistently receive positive feedback and high completion rates.

The server may also reduce an emphasis on topics that users frequently skip.

The server modifies prompt construction rules based on this feedback. The server may adjust the first prompt sentence to prioritize certain content categories or exclude others. For example, the server may prepend text such as “Focus on hiking and photography tips, and avoid detailed financial market news because the user often skips that section.” The server may also change the second prompt sentence to adjust video length, emphasize specific scenes, or change expression style. By dynamically modifying the generation conditions in this way, the server controls the behavior of the generative AI model and the text-to-video model to produce content that better matches user behavior patterns.

This integrated architecture improves the operation of the underlying computer technology in several ways. The server reduces processing load by generating content that is more likely to be consumed, thereby avoiding unnecessary generation of long or irrelevant outputs. The server improves memory and storage efficiency by producing short videos with scene structures tailored to user engagement, thereby limiting redundant or unused segments. The server improves network utilization by controlling video length and aspect ratios in response to viewing history, which can reduce data transfer volumes. The server improves personalization accuracy by using user profiles and feedback to parameterize prompt sentences, leading to more precise control of the generative AI model behavior compared to static prompts.

The generative AI model used for text generation can be trained using a supervised learning procedure in which the model minimizes a cross-entropy loss between predicted and actual tokens of target sequences, given input prompt sentences. The text-to-video model can be trained using a diffusion process that starts from noise and iteratively refines latent representations under the guidance of a text embedding, minimizing a mean squared error or similar objective between true and predicted denoising steps. The server uses pre-trained models and adapts them at inference time through prompt engineering and control parameters. In some variations, the server additionally fine-tunes a lightweight adapter module inside the generative AI model based on aggregated feedback signals, thereby reducing the need to retrain the entire network while allowing adaptation to user populations.

The server employs data structures that are specifically designed to support this closed-loop control. For instance, the server may store, for each user, a profile record that includes a vector representation of interests, a set of scalar weights representing emphasis levels for different content classes, and a history of prompt templates and their performance scores.

When the server constructs a new first prompt sentence, it reads the current vector and weights and applies a rule-based or learned transformation to produce text instructions in natural language. This explicit mapping from numerical profile representations to natural language instructions allows the server to steer the generative AI model in a way that conventional static prompting cannot achieve. The result is a tangible improvement in computational efficiency and user-aligned output.

The server can be implemented in alternative configurations. In one variation, the server hosts the generative AI model and the text-to-video model on separate machines, distributing computational load across multiple hardware accelerators. The server may use a queue-based scheduling system to batch multiple requests and to adjust batch size based on current load, thereby improving throughput and resource utilization. In another variation, the server uses a single shared encoder for both text generation and video generation, reducing duplication of computations when both models process similar prompt sentences.

The terminal can also vary. In one embodiment, the terminal is a mobile device using a mobile operating system, and the terminal executes a native application that communicates directly with the server's application programming interface. In another embodiment, the terminal is a desktop computer running a web browser that interacts with the server via web protocols. In both cases, the terminal's data collection and feedback transmission modules are configured to conform to the server's data structures so that the server can integrate information from different terminal types.

By structuring the flow of data from user activity and location information through feature extraction, profile generation, prompt sentence construction, generative AI invocation, video scenario creation, and feedback-driven adaptation, the server implements a specific technical solution that goes beyond simple automation of human curation. The server employs specialized data structures, control parameters, and model interaction logic to coordinate multiple computational components, thereby improving processing speed, personalization accuracy, data management, and network efficiency in a manner that is closely tied to the operation of the computer system itself.

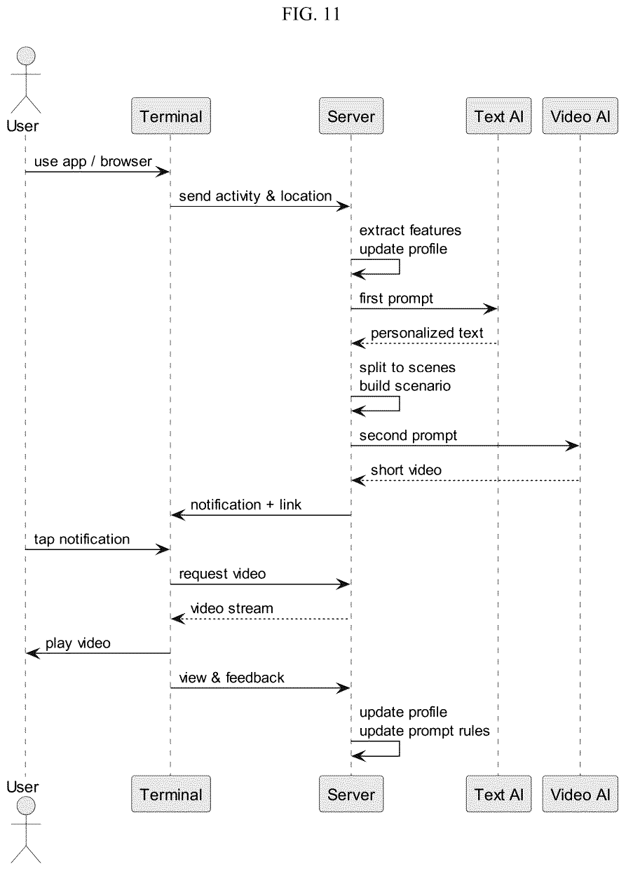

The following describes the processing flow using FIG. 11.

### Step 1:

Server acquires raw user data.

Server receives, as input, online activity information and location information from Terminal and external service interfaces. Server obtains, from Terminal, records including visited resource identifiers, search query strings, timestamps, and position coordinates, and obtains, from external service interfaces, social interaction records such as post texts and reaction data. Server parses the received payloads, validates formats, and normalizes fields such as user identifiers, time stamps, and data type codes. Server outputs structured records stored in database tables for search events, social posts, and location samples, each record being linked to a user identifier.

### Step 2:

Server extracts feature data from the raw user data.

Server receives, as input, the structured records stored in the database for a given user. Server performs tokenization and normalization of text fields from search events and social posts, computes term frequencies and n-gram counts, and applies statistical or embedding-based methods to convert the text into numerical vectors. Server clusters or groups these vectors to determine dominant topics and interest categories. Server processes location samples by aggregating coordinates over time, computing frequently visited regions and visit frequencies. Server combines the text-based features and location-based features into a unified feature vector set, and outputs feature data representing user preferences, interests, and behavior patterns.

### Step 3:

Server generates and updates a user profile.

Server receives, as input, the feature data for a particular user. Server maps the feature data into a structured user profile by assigning values to fields such as main interest topics, preferred content categories, active time ranges, and frequently visited areas. Server may compute scalar weights for each topic by normalizing term frequencies or cluster membership scores. Server writes the resulting user profile structure into a profile storage table keyed by the user identifier, either creating a new record or updating an existing record. Server outputs an updated user profile object that is ready for use in content generation.

### Step 4:

Server constructs a first prompt sentence for a generative AI model.

Server receives, as input, the user profile object containing topic weights, location summaries, and content preferences. Server selects a prompt template corresponding to a target content type, such as a daily briefing or a weekend recommendation. Server inserts specific profile values into the template and appends explicit instructions regarding output structure, length, and style. For example, Server creates a prompt sentence such as: “Analyze the following user profile and generate a personalized daily briefing for this user. The briefing should include: (1) one outfit suggestion suitable for today's weather, (2) three main news headlines with one-sentence summaries, and (3) two short tips related to the user's main hobbies. Use concise and friendly language. User profile: [profile content].” Server outputs the constructed first prompt sentence as a text string formatted for input to the generative AI model.

Step 5:

Server obtains personalized text information from a generative AI model.

Server receives, as input, the first prompt sentence. Server tokenizes the prompt sentence, encodes it as a sequence of token identifiers, and transmits these identifiers to a generative AI model via an interface. Server instructs the model to perform inference with specified parameters such as maximum token length and sampling temperature. The generative AI model processes the token sequence and returns an output token sequence that represents personalized information in text form. Server decodes the token sequence back into characters and text, checks for structural markers or headings, and validates that the response satisfies basic format constraints. Server outputs the personalized information as a structured text document.

### Step 6:

Server segments the personalized information into scene units.

Server receives, as input, the personalized text document from the generative AI model.

Server analyzes the text to identify logical sections, using markers such as headings, bullet lists, or sentence boundaries. Server assigns each section to a scene unit, for example mapping an outfit section, multiple news items, and hobby tips to separate scene identifiers. Server may limit or merge sections based on a target maximum number of scenes. Server outputs a list of scene units, each containing a subset of the personalized text.

### Step 7:

Server constructs a video scenario with control parameters.

Server receives, as input, the list of scene units. Server selects, for each scene unit, a visual template based on the scene category, such as “character with background,” “icon with text overlay,” or “illustrative animation.” Server generates visual content information for each scene by describing backgrounds, objects, and character actions, and generates subtitle information by summarizing the key text for display. Server assigns control parameters to each scene, including scene duration, video aspect ratio, expression style, and display text formatting. Server aggregates all scenes, visual content information, subtitles, and control parameters into a coherent video scenario data structure. Server outputs the video scenario representing the planned short video.

### Step 8:

Server constructs a second prompt sentence for a text-to-video generative AI model.

Server receives, as input, the video scenario containing scene definitions and control parameters. Server transforms the scenario into natural language instructions, describing the overall video and the content of each scene in order. Server incorporates control parameters such as total duration and aspect ratio into the text, and specifies desired visual style and caption usage. For example, Server generates a second prompt sentence such as: “Generate a 30-second vertical video (1080x1920) that consists of 4 scenes: Scene 1 (intro): show a simple animated title card with the text ‘Your Personal Morning Briefing’. Scene 2 (outfit): show a person standing near an office building wearing the recommended outfit, with a text overlay ‘Today's outfit suggestion’. Scene 3 (news): show dynamic icons and short captions summarizing three main news headlines. Scene 4 (hobby tips): show quick visual icons and short captions illustrating two tips related to the user's main hobby. Use a clean, modern style with soft colors and readable captions.” Server outputs the second prompt sentence as text suitable for the text-to-video model.

### Step 9:

Server generates short video data using the text-to-video generative AI model.

Server receives, as input, the second prompt sentence and associated control parameters.

Server encodes the prompt sentence, transmits the encoded representation to a text-to-video generative AI model, and requests generation of a video sequence with specified length and resolution. The text-to-video generative AI model iteratively denoises latent representations under the guidance of the text encoding and outputs a sequence of video frames. Server collects the generated frames, encodes them into a compressed video format, and performs verification of duration, resolution, and encoding format. If necessary, Server applies transcoding or resizing operations. Server outputs the resulting short video data as a media file.

### Step 10:

Server stores the generated short video data and prepares notification data.

Server receives, as input, the short video data file. Server writes the file to an external storage device and obtains identification information such as a storage path or a resource locator.

Server stores a record in a content management table linking the user identifier, the video identifier, and associated metadata such as creation time, duration, and topic tags. Server constructs notification data including a brief message, optional preview information, and the identification information required to access the video. Server outputs the notification data as a message object ready for transmission through a communication network.

### Step 11:

Server transmits notification data to Terminal.

Server receives, as input, the notification data and the target terminal identifier associated with the user. Server selects an appropriate delivery channel, such as a push notification service or an application programming interface of a communication or search application.

Server packages the notification data into a protocol-specific message, attaches routing information, and transmits the message through a communication network to Terminal.

Server outputs a transmission status indicating success or failure.

### Step 12:

Terminal presents the notification and requests video playback.

Terminal receives, as input, the notification data via its communication interface. Terminal passes the message to an operating system notification subsystem, which displays a notification on the screen. User observes the notification and may select it via a touch input or a pointing device. In response, Terminal launches a viewer application or opens a web browser and constructs a request message using the identification information contained in the notification data. Terminal transmits the request to Server or directly to the external storage device. Terminal outputs a playback request destined for the video resource.

### Step 13:

Terminal retrieves and plays the short video data.

Terminal receives, as input, video data or a video stream in response to the playback request.

Terminal decodes the video frames using a hardware decoder or a software media library, and renders the frames on the display while outputting any accompanying audio through a speaker. Terminal may overlay subtitles or captions if they are embedded or provided separately. Terminal outputs the rendered video to User, who views the personalized short video content.

### Step 14:

Terminal collects viewing history and feedback information.

Terminal receives, as input, user interaction events and playback state changes during video viewing. Terminal records data such as playback start and end times, pause and resume events, seek operations, skip events, completion state, and any user feedback actions such as “like,” “dislike,” or “not interested.” Terminal aggregates these events into viewing history information and feedback information structures. Terminal outputs these structures as telemetry data to be sent to Server.

### Step 15:

Server updates the user profile and prompt generation conditions.

Server receives, as input, the viewing history information and feedback information from Terminal. Server associates the received data with the corresponding video identifier and user identifier, and stores the data in feedback and log tables. Server computes metrics such as completion rate, average watch time, and frequency of positive or negative feedback for each content type and scene category. Server updates weights or preference scores within the user profile based on these metrics, for example increasing weights for popular topics and decreasing weights for frequently skipped topics. Server adjusts rules for constructing the first and second prompt sentences, such as changing the priority of topics, modifying length constraints, or altering style instructions. Server outputs an updated user profile and updated prompt construction parameters, which will be used as input in subsequent executions of Steps 4 and 8.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information provision and advertising systems that attempt to personalize content for users often rely on static rules, coarse demographic segmentation, or simple keyword matching applied to user data. Such approaches typically do not fully exploit heterogeneous user behavior data, such as detailed operation history and context-dependent location information, and therefore fail to accurately infer fine-grained user interests and preferences. As a result, the systems frequently deliver content that is only loosely related to a user's current intent, leading to low engagement rates and inefficient use of network and computation resources.

Moreover, known systems that employ content generation technologies, including generative artificial intelligence, generally treat the generation model as a black box that receives manually crafted prompts and returns text. These systems do not provide a systematic, machine-interpretable mechanism to derive prompt sentences from machine-learned user interest profiles, nor do they tightly integrate such prompt generation with subsequent automatic video composition. Consequently, the quality and consistency of the generated content remain highly dependent on human operators, and the system cannot scale efficiently or adapt rapidly to changes in user behavior.

In addition, existing video generation workflows are often built as disconnected pipelines: analysis of user data, script authoring, media asset selection, video editing, and delivery are performed by separate tools or services with minimal feedback. This fragmented architecture introduces latency, increases operational complexity, and prevents the system from closing the loop between user interaction with the delivered video and subsequent personalization logic. In particular, conventional systems do not feed structured usage record information, such as playback state or reaction signals, back into the underlying machine learning models in an automated manner, so the models do not continuously improve based on real user responses.

From a computer-technology perspective, there is a need for an improved technical architecture that: (i) transforms diverse user data (operation history and location) into unified numerical and categorical features; (ii) leverages a machine learning model to compute structured interest classifications and scores; (iii) automatically converts such model outputs into structured prompt sentences for a generative artificial intelligence model; (iv) converts the generative model's text output into time-aligned audio and visual data; (v) composes a time-constrained video through controlled programmatic video processing; and (vi) collects and reuses detailed usage record information as feedback to update the machine learning model. Without such an integrated, feedback-driven pipeline, the computer system cannot efficiently generate high-relevance, short-duration videos at scale with reduced human intervention and with improved use of computational and network resources.

The specific processing by the specific processing unit 290 of the data processing device 12 in Application Example 1 is realized by the following means.

The present invention provides a server comprising a processor and a storage device, the processor being configured to acquire user operation history information and location information via a sensor apparatus or an information acquisition program unit, store the acquired information in the storage device, preprocess the user operation history information using a character string processing function and a feature value calculation function to obtain numerical feature values, convert the location information into regional attributes using a geographic information association function, input the numerical feature values and the regional attributes into a machine learning model to calculate a classification result relating to a user interest or preference and interest degree information based on the classification result, generate an information provision plan including at least a video length, a scene configuration, explanation content, tone, and appeal content on the basis of the classification result and the interest degree information, automatically generate a structured prompt sentence to be input to a generative artificial intelligence model in accordance with the information provision plan, obtain text information from the generative artificial intelligence model in response to the prompt sentence, divide the text information on a per-scene basis, generate audio data for respective scenes using a speech synthesis function, obtain visual data for the respective scenes using an image generation function or an image retrieval function, record the audio data and the visual data as configuration information associated with time information, generate video data having a predetermined time length by using a video composition processing program on the basis of the configuration information by arranging the visual data, the audio data, and subtitle text information on a time axis, register the generated video data in the storage device or an external storage service, generate notification information including identification information and description information associated with the video data, transmit the video data or reference information to the video data to a user terminal by using a communication function of a communication application or an information retrieval program, receive usage record information from the user terminal indicating at least a playback state, an operation state, or reaction information relating to the video data, and reuse the usage record information as input or learning information for the machine learning model to update the classification result and processing for generation of the prompt sentence. This enables an integrated, computer-implemented pipeline that automatically transforms heterogeneous user behavior data into structured interest profiles, adaptively generates prompt sentences and short video content using a generative artificial intelligence model and programmatic video composition, and continuously improves personalization quality and system efficiency by feeding back usage record information into the underlying machine learning model.

The term “user operation history information” refers to data indicating interactions performed by a user with applications, services, or content on a computing apparatus, including at least search queries, content viewing records, selection operations, and input operations, each associated with a time at which the interaction occurred.

The term “location information” refers to data indicating a geographic position related to a user or a user terminal, including at least coordinates, area identifiers, or region codes, which can be obtained from a positioning sensor or a network-based positioning service.

The term “sensor apparatus” refers to a hardware device or a combination of hardware devices configured to detect physical or environmental conditions, such as position, motion, or proximity, and to output corresponding digital data.

The term “information acquisition program unit” refers to a software component executed by a processor and configured to obtain user-related data from operating system interfaces, application logs, communication interfaces, or external services.

The term “storage device” refers to any physical or virtual memory apparatus, including volatile memory, non-volatile memory, or external storage service, configured to store data, programs, or configuration information.

The term “character string processing function” refers to a software function or module configured to perform operations on text data, including at least tokenization, normalization, segmentation, or removal of unnecessary elements.

The term “feature value calculation function” refers to a software function or module configured to transform raw data into numerical representations, including at least calculation of statistical values, vector representations, or encoded features suitable for input to a machine learning model

The term “geographic information association function” refers to a software function or module configured to map location information to geographic attributes, such as region categories, place types, or area classifications.

The term “regional attributes” refers to categorical or numerical indicators representing a classification of a geographic area, such as an urban area, commercial area, residential area, or recreational area.

The term “machine learning model” refers to a computational model generated or trained using example data, configured to perform prediction, classification, regression, or scoring by processing input feature values.

The term “classification result” refers to output information generated by a machine learning model that indicates one or more categories or labels associated with a user, such as interest categories or preference categories.

The term “interest degree information” refers to numerical values or scores indicating a strength or degree of association between a user and one or more interest categories or preference categories.

The term “information provision plan” refers to structured data defining parameters and content design for providing information to a user, including at least video length, scene configuration, explanation content, tone, and appeal content.

The term “generative artificial intelligence model” refers to a computational model trained to generate new data, such as text, images, or audio, in response to input data, including input in the form of a prompt sentence.

The term “prompt sentence” refers to text data provided as an instruction, condition, or context to a generative artificial intelligence model to cause the model to generate corresponding output content.

The term “structured prompt sentence” refers to a prompt sentence that is formulated based on structured information, including at least interest categories, themes, time constraints, and scene constraints, and that is suitable for machine-driven generation.

The term “text information” refers to data expressed in a sequence of characters or symbols, including at least narrative sentences, scene descriptions, scripts, or caption strings generated by a model or a program.

The term “speech synthesis function” refers to a software function or module configured to convert text information into audio data representing spoken language.

The term “audio data” refers to digital data representing sound, including at least spoken narration, sound effects, or music, formatted for playback by an audio output device.

The term “image generation function” refers to a software function or module configured to generate still images or visual frames based on text information or other input data.

The term “image retrieval function” refers to a software function or module configured to search for and obtain existing visual data, such as images or video segments, from a storage device or an external resource on the basis of search conditions.

The term “visual data” refers to digital data representing visual content, including at least images, video frames, or short video segments suitable for presentation on a display.

The term “time information” refers to data indicating temporal relationships, including at least timestamps, durations, or start and end times associated with audio data or visual data.

The term “configuration information” refers to structured data that associates at least visual data, audio data, subtitle text, and time information, and that defines how such data are to be arranged in a composite video.

The term “video composition processing program” refers to a software program or library configured to combine multiple media elements, including visual data, audio data, and text overlays, into a single video data file according to configuration information.

The term “subtitle text information” refers to character string data intended to be displayed over visual content in temporal synchronization with audio data to present supplementary or alternative textual information.

The term “video data” refers to digital data representing a time-varying visual sequence, optionally including associated audio, encoded in a format suitable for decoding and playback by a media player.

The term “identification information” refers to data that uniquely or distinctively identifies an item of video data, such as an identifier, a name, or a reference key.

The term “description information” refers to data that describes content or characteristics of video data, including at least a title, a summary, or a keyword set.

The term “notification information” refers to data forming a message that prompts a user terminal to present an alert or message to a user, including at least identification information, description information, and reference information for accessing video data.

The term “communication application” refers to a software application executed on a user terminal that provides message exchange, notification, or communication functions between users or between a user and a server.

The term “information retrieval program” refers to a software application or component configured to receive search queries from a user and return relevant information or content, and to provide a notification function related to such information.

The term “reference information” refers to data enabling access to video data, including at least a resource locator, an access token, or a link.

The term “user terminal” refers to an electronic device operated by or associated with a user, such as a smartphone, tablet, or personal computer, capable of receiving, processing, and displaying content and notifications.

The term “usage record information” refers to data indicating how a user or a user terminal has interacted with video data, including at least playback state, operation state, reaction information, timestamps, and event types.

The term “playback state” refers to information indicating a status of playback of video data, including at least start, pause, resume, completion, or termination before completion.

The term “operation state” refers to information indicating explicit manipulation performed by a user with respect to video data or a player interface, including at least volume change, seeking, skipping, or selection operations.

The term “reaction information” refers to information indicating a user's response to video data, including at least evaluation signals, selection of related content, link activation, or sharing actions.

The term “external storage service” refers to a remotely accessible storage system provided over a network, configured to store and retrieve data such as video data, audio data, or visual data in response to access requests.

The term “communication function” refers to hardware and software components that enable data transmission and reception between a server and a user terminal or between systems over a wired or wireless network.

In one embodiment, a server cooperates with one or more terminals operated by a user to implement a system for generating and delivering personalized, short-duration videos based on user operation history information and location information. The server includes at least one processor, a main memory, a non-volatile storage device, and a network interface.

The terminal includes at least one processor, a memory, a display, an audio output device, input devices such as a touch screen, and a wireless communication interface.

The server executes a server program on an operating system running on a hardware platform such as a general-purpose computer or a virtual machine. The server program is implemented, for example, in a high-level programming language and uses standard server software components such as a web server, an application server, and a database management system.

The server program is configured as a set of modules including a data acquisition module, a feature extraction module, a machine learning module, a prompt generation module, a generative AI interaction module, a media asset generation module, a video composition module, a delivery control module, and a feedback processing module.

The terminal executes an application program such as a communication application or an information retrieval program on an operating system for a mobile device. The terminal program obtains user operation history information and location information using operating system APIs. The terminal obtains, for example, search query text entered by the user, content selection events such as viewing items or opening pages, and interaction events such as clicking buttons or links. The terminal obtains approximate location information from positioning subsystems such as a satellite positioning module or a network-based location service. The terminal transmits such information to the server in a structured format using a secure communication protocol.

The server stores the received user operation history information and location information in a storage device such as a relational database and an object store. The server maintains, for each user, records including a user identifier, a timestamp, an operation type, an operation parameter such as a search query string, and a location field containing coordinates or an area identifier. The server uses an index structure such as a B-tree index for the user identifier and the timestamp to support efficient retrieval of recent data.

The server performs text preprocessing of operation history information containing textual content. The server uses a character string processing function implemented with a natural language processing library to tokenize search queries and user-generated text into word units, normalize character forms, and remove stopwords based on a predefined list. The server then applies a feature value calculation function to convert tokens into numerical feature values. In one embodiment, the server uses a term frequency-inverse document frequency (TF-IDF) scheme to compute a sparse vector representation of each text, where each dimension corresponds to a token in a vocabulary and each value corresponds to a weighted frequency. In another embodiment, the server uses a word embedding model to map tokens into dense vectors in a continuous vector space and averages or otherwise aggregates the vectors per user.

The server converts location information into regional attributes using a geographic information association function. The server maps latitude and longitude values to region identifiers such as “urban commercial district,” “residential area,” or “recreational park” by comparing the coordinates with a pre-stored geofence table or by invoking an external mapping service API. The server encodes these region identifiers as one-hot vectors or as categorical indices and stores them together with the text-derived feature values.

The server aggregates feature values across multiple operation history records and associated location records for each user. The server uses an aggregation rule, for example, a weighted average based on recency, to generate a single feature vector per user that concatenates text-based numerical feature values with regional attribute encodings. This unified feature vector constitutes an input to a machine learning model.

The server implements the machine learning model using a neural network architecture configured and trained to output classification results relating to user interests or preferences and corresponding interest degree information. In one embodiment, the server uses a feed-forward neural network with an input layer corresponding to the dimension of the unified feature vector, one or more hidden layers with nonlinear activation functions such as rectified linear units, and an output layer with a softmax activation function for multiple interest categories. The server trains the neural network using labeled historical user data stored in the storage device. The server defines a loss function such as categorical cross-entropy and uses an optimization algorithm such as stochastic gradient descent or an adaptive gradient method to update weight parameters. The server may perform techniques such as mini-batch training, dropout regularization, and early stopping to prevent overfitting. The server may also perform data augmentation by, for example, randomly masking low-importance tokens or slightly perturbing regional attributes to make the model robust to noise.

By using such a trained machine learning model, the server calculates, for each user feature vector, a probability distribution over a plurality of interest categories. The server interprets the output as a classification result indicating which interest categories apply to the user and as interest degree information indicating confidence scores or strengths for each category. The server stores the classification result and the interest degree information in the storage device in association with the corresponding user identifier.

The server generates an information provision plan based on the classification result and the interest degree information. The server uses a rule-based planning module configured with a mapping between interest categories and content themes, video structures, and desired tones.

The server selects one or more high-scoring interest categories per user and derives a corresponding theme such as “camping equipment,” “travel accessories,” or “fitness gear.” The server defines parameters of the information provision plan including a total video length (for example, 30 seconds), a number of scenes, a time allocation per scene, explanatory content per scene, a tone such as “friendly” or “authoritative,” and an appeal content such as a call-to-action phrase.

The server then generates a structured prompt sentence to be input to a generative AI model.

The server constructs the prompt sentence by inserting the selected theme, the number of scenes, the total time constraint, and required elements such as inclusion of a call-to-action into a template. The server may also embed constraints on output format, such as requiring clear headings for each scene and clear indication of narration text and subtitle text.

The server may generate a prompt sentence as follows:

“Based on the user's recent behavior, the user is highly interested in travel and outdoor camping gear. Please generate a complete script for a 30-second promotional video. Divide the script into 5 scenes, include detailed narration text for each scene, and provide short on-screen captions. Highlight a lightweight tent, a compact sleeping bag, and a portable stove.

Use an enthusiastic and friendly tone, and end with a clear call-to-action encouraging the user to explore more products online.”

The server transmits the prompt sentence to a generative AI model via a programmatic interface. The generative AI model is, for example, a large language model implemented as a deep neural network with an encoder-decoder architecture or a transformer architecture. The generative AI model has been trained in advance on a large corpus of text data by minimizing a prediction error function such as cross-entropy over sequences of tokens, using parameter updates via backpropagation.

The server receives text information generated by the generative AI model in response to the prompt sentence. The text information typically includes scene-by-scene descriptions, narration sentences, and suggested subtitles. The server parses the text information to identify scene boundaries based on scene headings or markers. The server then creates, for each scene, a data structure including a scene identifier, a time segment, narration text, a scene description, and subtitle text.

The server generates audio data for each scene using a speech synthesis function provided by a text-to-speech engine. The server supplies the narration text to the text-to-speech engine and receives digital audio data in a format suitable for playback. The server stores the audio data in an audio object store and records, for each scene, a reference to the corresponding audio file.

The server obtains visual data for each scene by using an image generation function or an image retrieval function. In one implementation, the server uses an image generation model, such as a generative neural network trained for image synthesis, to create images corresponding to scene descriptions. The server provides textual scene descriptions as input and receives image data depicting, for example, a campsite, a user interacting with a product, or a scenic location. In another implementation, the server uses an image retrieval function to query a stock image or video database using keywords extracted from the scene descriptions.

The server retrieves matching images or short video segments and stores them in an image repository.

The server associates the audio data, the visual data, and subtitle text information with time information to form configuration information. The server defines, for example, for each scene, a start time, an end time, identifiers of visual and audio assets, and subtitle text with corresponding display times. The server records the configuration information in a structured representation such as a timeline data structure.

The server uses a video composition processing program, such as a multimedia processing framework, to generate video data based on the configuration information. The server controls the video composition processing program to load the visual assets as input frames or clips, the audio data as an audio track, and the subtitle text as overlay text. The server instructs the program to arrange the assets along the time axis according to the configuration information, applying transition effects such as fades between scenes and synchronizing the audio track with the visual sequence. The server configures the program to encode the resulting video into a compressed format such as a moving picture file encoded with a specific codec and audio codec.

The server registers the generated video data in the storage device or in an external storage service. The server assigns a unique identifier to each video, stores metadata including resolution, duration, interest category, and timestamp of creation, and obtains a reference such as a resource locator for the video. The server then generates notification information containing at least the video identifier, descriptive text, and the reference to the video data.

The server transmits the notification information and the reference to the video data to the terminal using a communication function of a communication application or an information retrieval program. The server uses, for example, a push notification service or an application programming interface provided by the communication application to send a message that, when received by the terminal, results in a visible notification.

The terminal receives the notification and presents it to the user through a notification mechanism of the operating system. The user may select the notification to open a screen where the video is accessible. The terminal then retrieves the video data using the provided reference, for example, by requesting the video from the server or the external storage service via a network protocol. The terminal decodes the video using hardware-accelerated codecs and displays the visual content on the display while reproducing the audio via the audio output device.

The terminal collects usage record information during playback. The terminal records whether the video was started, how long it was played before termination, whether the user paused, resumed, or skipped sections, and whether the user performed explicit reactions such as liking, sharing, or following links presented during or after playback. The terminal sends these usage record events back to the server in a structured format.

The server stores the received usage record information in a log database and aggregates the information at the user level and the content level. The server converts usage record information into additional feature values, such as a completion rate per category or a preference score for certain tones or scene structures. The server then uses this feedback as additional input to the machine learning model. In one embodiment, the server augments the training dataset with new examples labeled according to user engagement levels, thereby continuing to refine the model weights. In another embodiment, the server updates the user interest degree information by combining model outputs with observed feedback using a rule-based or Bayesian update method.

By integrating user feedback into the model and prompt generation process, the server gradually shifts the system toward content structures and themes that demonstrably increase engagement. This closed feedback loop improves not only the accuracy of the classification result but also the relevance of the information provision plan and the generated prompt sentence. Because the server controls the internal representation of user interests, the transformation into structured prompt sentences, and the mapping from generative AI text output to time-aligned media assets, the system improves computational efficiency by avoiding repeated manual intervention and by reducing unnecessary generation of low-relevance content.

The server thereby improves computer technology in several ways. First, the server introduces a specific data structure that unifies heterogeneous user signals-textual operation history and location-based regional attributes-into a single feature vector optimized for neural network processing. This structure reduces dimensional redundancy and allows fewer parameters to achieve a given accuracy, improving computation speed and memory usage. Second, the server implements a non-conventional integration between a discriminative machine learning model for user interest classification and a generative AI model, such that the discriminative model's outputs directly parameterize the prompt sentence generation process. This configuration allows the generative AI model to receive more precise, machine-derived constraints than manually crafted prompts, resulting in a more predictable and controllable generation process.

Third, the server defines a concrete transformation chain from generative text to synchronized audio, images, and final video with fixed duration and pre-defined structure. By encoding scene-level timing, narration, and visual assets into configuration information consumed by a video composition processing program, the server offloads repeated low-level editing operations to an automated, deterministic workflow. The server can thereby generate many personalized videos in parallel, with optimized use of CPU and GPU resources for media encoding.

Fourth, the server uses the detailed usage record information not merely for business analytics but as structured machine learning input to iteratively refine the feature extraction and classification process. Because the feedback loop is defined at the level of feature vectors and model parameters, the server is able to reduce prediction error, shorten latency between observation and adaptation, and decrease the number of irrelevant items delivered to terminals. This results in less network traffic for content that is unlikely to be consumed, thereby reducing communication load.

The server can adopt alternative embodiments within the same technical framework. In one variant, the server employs a recurrent neural network or a transformer-based model as the machine learning model, using sequences of operation history events as input and applying attention mechanisms to weigh recent behaviors more heavily. In another variant, the server segments users into clusters by applying an unsupervised learning algorithm such as k-means to the unified feature vectors and uses cluster assignments as additional input features to the classification model. In yet another variant, the server uses different generative AI models for different output modalities, such as one model optimized for narrative scripts and another for generating prompts to an image synthesis model.

The terminal may also vary in form. For example, in one embodiment, the terminal is a smartphone using a native application to receive and play videos. In another embodiment, the terminal is a smart television or a set-top box that receives notification information from the server and displays personalized videos on a larger screen. In each case, the terminal performs similar technical functions: receiving references to video data, decoding video streams, presenting synchronized audio-visual content, and recording detailed user interaction events.

The user uses the system without knowledge of the internal processing. The user simply performs everyday operations such as searching for information, browsing content, and interacting with videos. The server and the terminal, by implementing the above-described modules, algorithms, and data flows, automatically realize the generation and delivery of short personalized videos and continuously refine the relevance and structure of such content. Through these concrete technical mechanisms, the system moves beyond a mere automation of human creative tasks and instead provides a structured improvement of computer-based data processing, model integration, and media generation.

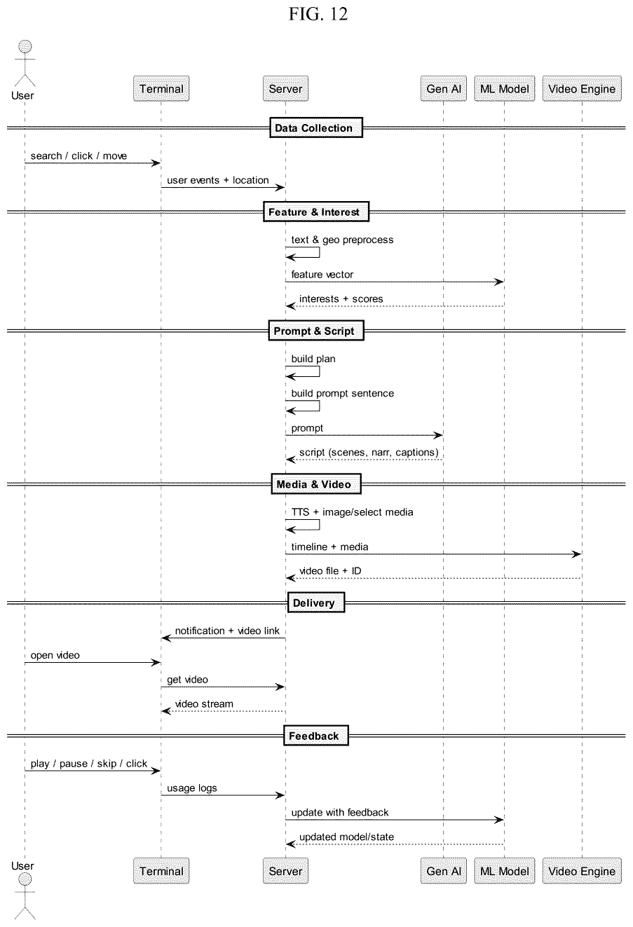

The following describes the processing flow using FIG. 12.

### Step 1:

The terminal acquires user operation history information and location information. The input to this step is user interaction events such as search queries, page views, button clicks, and application usage events, as well as raw position data from positioning hardware. The terminal uses operating system APIs to capture text entered by the user (for example, a search string), identifiers of selected content (for example, a product ID), timestamps, and geographic coordinates from a positioning subsystem. The terminal packages these data fields into a structured event record and outputs a sequence of such event records for transmission to the server.

### Step 2:

The terminal transmits the event records to the server. The input to this step is the sequence of structured event records generated in Step 1. The terminal establishes a secure communication channel using a network stack, serializes the event records into a message format such as JSON, and sends the message via a network protocol to a known server endpoint. The terminal outputs the transmitted message as network packets containing the user operation history information and location information.

### Step 3:

The server receives and stores the user operation history information and location information. The input to this step is the message containing serialized event records from the terminal. The server uses a network interface and web server software to parse the incoming message, validate authentication tokens, and check data formats. The server then writes each event record into one or more database tables, mapping fields such as user identifier, timestamp, operation type, text content, and coordinates into corresponding columns. The server outputs persisted records in a storage device, indexed by user identifier and time.

### Step 4:

The server performs text preprocessing and feature extraction on the operation history. The input to this step is a set of stored event records containing textual fields such as search queries and user-generated text. The server reads the relevant database rows, then uses a character string processing function to tokenize each text into words, convert characters to a normalized form, remove stopwords, and perform lemmatization. The server then applies a feature value calculation function, such as TF-IDF or word embeddings, to convert each processed text into a numerical feature vector. The server aggregates these vectors per user, for example by computing a weighted average based on recency, and outputs a user-level text-based feature vector.

### Step 5:

The server converts location information into regional attributes. The input to this step is a set of stored event records containing geographic coordinates linked to each user. The server reads coordinate values and calls a geographic information association function, which compares the coordinates with a geofence table or an external map service to determine region categories such as commercial area, residential area, or recreational area. The server encodes these categories as one-hot vectors or category indices and aggregates them per user. The server outputs a user-level regional attribute vector.

### Step 6:

The server constructs a unified feature vector per user. The input to this step is the user-level text-based feature vector from Step 4 and the user-level regional attribute vector from Step 5.

The server concatenates these vectors into a single high-dimensional vector and may perform normalization or dimensionality reduction operations to standardize the scale. The server outputs a unified feature vector that captures both textual behavior and location context for each user.

### Step 7:

The server performs interest classification using a machine learning model. The input to this step is the unified feature vector for each user. The server loads a trained neural network model and feeds the unified feature vector into the input layer. The server computes activations through hidden layers using weight matrices and nonlinear functions, and obtains output scores at the final layer representing probabilities for each interest category. The server interprets the output scores as a classification result and interest degree information, selects top categories based on thresholding or ranking, and outputs structured interest data for each user.

### Step 8:

The server generates an information provision plan based on the interest data. The input to this step is the structured interest data comprising interest categories and corresponding scores. The server applies rule-based logic to map high-scoring categories to content themes, determines a target video length such as 30 seconds, and chooses a number of scenes. The server allocates time to each scene, defines a type of explanation content, selects a tone (for example, friendly or formal), and decides on a call-to-action. The server assembles these parameters into an internal plan structure and outputs an information provision plan for the user.

### Step 9:

The server generates a prompt sentence for a generative AI model. The input to this step is the information provision plan including theme, scene count, time constraints, tone, and call-to-action requirement. The server embeds these parameters into a prompt template, for example inserting the theme name, specifying “30-second video,” and requesting scene-by-scene narration and captions. The server concatenates the template segments into a coherent text instruction, ensuring that formatting cues such as “Scene 1,” “Narration,” and “Caption” are included. The server outputs a complete prompt sentence suitable for input to a generative AI model.

### Step 10:

The server sends the prompt sentence to the generative AI model and receives generated text information. The input to this step is the prompt sentence created in Step 9. The server constructs an API request containing the prompt and model parameters such as temperature and maximum token count, and transmits the request to a generative AI service. The server receives a response containing generated text that describes multiple scenes, narrations, and captions. The server parses the response text to detect scene boundaries and output tags, and outputs structured per-scene text information including scene descriptions, narration text, and subtitle candidates.

### Step 11:

The server generates audio data from the narration text. The input to this step is the per-scene narration text from Step 10. The server calls a speech synthesis function for each scene, specifying a voice type, speaking rate, and language parameters. The speech synthesis function converts the text into waveform data and returns audio files such as compressed audio streams. The server stores each audio file and associates it with the corresponding scene identifier. The server outputs references to audio data linked to scenes.

### Step 12:

The server generates or retrieves visual data for each scene. The input to this step is the per-scene description text and possibly extracted keywords. The server either invokes an image generation function to create new images from the description or invokes an image retrieval function to search an existing media repository using query terms derived from the scene text.

The server selects one or more images or short clips that best match the scene description based on similarity scores or ranking algorithms. The server stores the selected visual assets and outputs references to visual data linked to scenes.

### Step 13:

The server constructs configuration information for video composition. The input to this step is the scene-level audio data references from Step 11 and visual data references from Step 12, along with subtitle text from Step 10 and timing constraints from the information provision plan. The server assigns a start time and end time to each scene such that the total duration matches the target video length. The server creates a timeline structure specifying, for each scene, which visual asset to display, which audio track to play, and what subtitle text to overlay at which time. The server outputs configuration information that fully defines the temporal arrangement of media elements.

### Step 14:

The server composes video data using a video composition processing program. The input to this step is the configuration information from Step 13. The server launches a multimedia processing program, passes file references to visual and audio assets along with overlay instructions for subtitles, and instructs the program to generate a continuous video track. The program decodes input assets, applies transitions, mixes audio with correct offsets, overlays subtitles according to the timeline, and encodes the resulting sequence into a compressed video file. The server monitors the process, verifies that the output video matches the intended duration and format, and outputs the generated video data along with its identifier.

### Step 15:

The server registers the generated video data and prepares notification information. The input to this step is the video data and metadata such as user identifier, theme, and creation time.

The server stores the video in a storage device or external storage service and assigns a uniform resource identifier or another reference token. The server then creates notification information containing a title, a brief description, and the reference to the video. The server outputs a notification object ready to be sent to the terminal.

### Step 16:

The server delivers the notification and video reference to the terminal. The input to this step is the notification object from Step 15. The server chooses an appropriate communication path, such as a push notification service or a messaging API, formats the notification into a protocol-specific payload, and sends it to the terminal's registered address or token. The server outputs the transmitted notification as network messages directed to the terminal.

### Step 17:

The terminal receives the notification and obtains the video data. The input to this step is the notification message sent from the server. The terminal's operating system delivers the notification payload to the corresponding application, which parses the content to extract the video reference and descriptive text. The terminal presents the notification to the user and, when the user selects it, initiates a request to the indicated resource locator or reference token.

The terminal uses a network client to fetch the video data from the server or storage service and outputs the received video data to the local media playback component.

### Step 18:

The terminal plays back the video and records usage events. The input to this step is the retrieved video data and user interactions with the media player. The terminal decodes the video stream using hardware or software decoders, renders the visual frames on the display, and plays the synchronized audio through speakers or headphones. The terminal monitors playback state changes such as start, pause, seek, completion, and early termination, and records user operations such as tapping a call-to-action button, adjusting volume, or skipping. The terminal outputs a sequence of usage record events annotated with timestamps and event types.

### Step 19:

The terminal sends usage record information to the server. The input to this step is the logged usage events from Step 18. The terminal serializes the events into a compact representation containing user identifier, video identifier, event type, and time, and transmits the representation to the server using a network protocol. The terminal outputs the transmitted usage record information as network messages directed to the server.

### Step 20:

The server processes usage record information and updates models and prompt generation behavior. The input to this step is the usage record information received from the terminal.

The server stores the events in a log database, aggregates metrics such as view completion rates and click-through rates per user and per interest category, and converts these metrics into additional features or labels. The server feeds these features into the machine learning module, for example by retraining the neural network with updated data or adjusting per-user interest degree values using a weighting formula. The server then modifies subsequent information provision plans and prompt sentence generation logic to emphasize content patterns associated with higher engagement. The server outputs updated model parameters, refined user interest data, and adjusted prompt generation rules that will be used as input when processing new user operation history information.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content recommendation systems typically identify user interests from coarse-grained indicators such as explicit ratings, simple click-through logs, or static profile attributes, and then present recommended items as lists of hyperlinks or textual summaries. Such architectures suffer from several technical limitations when implemented on modern distributed computing environments. First, existing systems generally treat user behavior logs, location information, and media generation as independent subsystems, resulting in fragmented data flows and repeated transformations between heterogeneous data formats.

This fragmentation leads to inefficient use of processing resources, increased latency from data acquisition to content delivery, and difficulty in maintaining consistency between user profiles and delivered content.

Second, many systems that invoke a generative AI model do so with manually crafted, static prompts, without systematically incorporating structured behavior features, viewing feedback, or context-dependent constraints. Consequently, server-side computing resources are consumed on generating content that is only weakly aligned with the user's actual behavior patterns, thereby reducing the effectiveness of the generative AI model and requiring additional post-processing or manual curation. This lack of tight coupling between feature extraction and prompt sentence construction further complicates scaling to large user populations, because the server cannot efficiently adapt prompts in response to evolving usage signals.

Third, conventional video generation pipelines typically treat text generation and multimedia synthesis as separate stages, often requiring human operators to interpret text output, decide scene segmentation, select media assets, and align narration with subtitles. When such pipelines are integrated into an automated service environment, they tend to introduce processing bottlenecks, complex orchestration logic, and synchronization errors between audio, subtitles, and visual elements. As a result, server-side systems experience increased processing time, higher memory consumption, and reduced reliability in generating and streaming short-duration video content to a variety of user terminals.

Fourth, feedback such as viewing completion rate or user reaction to generated video content is often not reintegrated into the upstream recommendation and generation pipeline in a structured and iterative manner. In many implementations, such feedback is stored separately or used only for offline analytics, rather than being directly fed into the feature extraction process and the construction of subsequent prompt sentences. This absence of a closed-loop feedback mechanism at the server level prevents the system from dynamically updating user profiles and prompts, leading to static or stale content and suboptimal utilization of computational resources devoted to generative AI inference and multimedia encoding.

Accordingly, there is a need for an improved computer-implemented system that, within a server-centric architecture, (i) unifies acquisition of user behavior history information and location information into a coherent behavior data set, (ii) performs feature extraction and user profile generation in a manner directly consumable by a generative AI model, (iii) automatically constructs and adapts prompt sentences based on both behavior-derived features and viewing feedback, and (iv) tightly integrates text generation, scene decomposition, media asset selection or generation, speech synthesis, and time-axis synchronization to automatically produce short-duration video content. Such a system should improve the efficiency, scalability, and consistency of the overall pipeline from data acquisition through content delivery, thereby constituting a concrete improvement in computer and network technology rather than merely automating a mental process or abstract idea.

The specific processing by the specific processing unit 290 of the data processing device 12 in Example 2 is realized by the following means.

The present invention provides a server comprising a processor and one or more storage resources, the processor being configured to acquire, via a communication interface, behavior history information and location information relating to a user from one or more external information processing apparatuses or external information providing apparatuses, to integrate the behavior history information and the location information into a unified behavior data set stored in the storage resources, to apply one or more character information processing algorithms and one or more feature extraction algorithms to the behavior data set to calculate feature quantities indicating at least a field of interest of the user and a behavior tendency of the user and to generate user profile data based on the feature quantities, to construct a prompt sentence including a generation instruction text, user context information derived from the user profile data, and one or more constraint conditions by combining the user profile data with predetermined template information, to input the constructed prompt sentence into a generative model having a natural language processing function executed on the server or on a connected computation resource, to obtain generated information including an explanatory text or a commentary text customized for the user as an output of the generative model and to store the generated information in association with the behavior data set in the storage resources, to divide the generated information into a plurality of scene information elements and subtitle information elements, to select or generate image information or video clip information corresponding to the respective scene information elements, to generate audio data based on the generated information by using a speech synthesis function executed by the server, to perform editing processing that synchronizes the image information or the video clip information, the subtitle information elements, and the audio data on a time axis so as to automatically generate short-duration video content data, to store the short-duration video content data in a storage device and generate access identification information for the short-duration video content data, to transmit the access identification information or the short-duration video content data itself to a user terminal through an interface of a notification service or a communication application, and to acquire viewing history information or reaction information relating to the short-duration video content data from the user terminal, to append the viewing history information or the reaction information to the behavior data set, and to update the feature quantities and the construction of subsequent prompt sentences based on the appended viewing history information or reaction information so that later generated information is dynamically adapted to the user. This enables the server to implement an integrated, closed-loop computation pipeline that efficiently transforms heterogeneous behavioral and feedback data into adaptive prompt sentences for a generative AI model and into time-synchronized short-duration video content, thereby improving the technical performance of content generation and delivery in terms of processing efficiency, scalability, synchronization accuracy, and relevance of generated multimedia content.

The term “behavior history information” refers to digital data representing past actions of a user, including but not limited to access logs, search queries, content viewing records, communication records, and interaction events generated by the user in association with one or more information processing apparatuses or services.

The term “location information” refers to digital data indicating a geographical position associated with a user or a user terminal, including but not limited to coordinates, region identifiers, or place identifiers obtained from a positioning function or a network-based location service.

The term “external information processing apparatus” refers to a computing resource separate from the server that acquires, stores, or processes data related to user activities and is accessible by the server via a communication network.

The term “external information providing apparatus” refers to a computing resource or service that supplies content or metadata, such as communication data, browsing data, or sensor data, to the server over a communication network.

The term “behavior data set” refers to a structured collection of digital records obtained by integrating behavior history information and location information associated with a user.

The term “character information processing algorithm” refers to a programmatic procedure for analyzing or transforming character-based data, including but not limited to tokenization, normalization, language detection, keyword extraction, and text classification.

The term “feature extraction algorithm” refers to a programmatic procedure that calculates one or more numerical or symbolic values, referred to as feature quantities, from input data such as the behavior data set, so as to represent characteristics such as user interests or behavior tendencies.

The term “feature quantity” refers to a numerical or symbolic value computed from data, representing a property or characteristic associated with a user, such as a degree of interest in a topic, an activity frequency, or a preferred time zone.

The term “field of interest” refers to a category or topic inferred for a user, such as a thematic area, subject matter, or content genre, identified on the basis of the user's behavior data set.

The term “behavior tendency” refers to a pattern in a user's actions or preferences, such as temporal habits, location-related habits, or content-consumption habits, derived from the behavior data set.

The term “user profile data” refers to structured data that aggregates feature quantities, fields of interest, and behavior tendencies of a user, and is used as contextual information for content generation.

The term “prompt sentence” refers to a text sequence or structured textual input including at least an instruction component, user context information, and one or more constraint conditions, which is supplied to a generative model to control the content and form of generated output.

The term “generation instruction text” refers to a portion of the prompt sentence that explicitly specifies a task to be performed by the generative model, such as generating an explanatory text or a commentary text.

The term “user context information” refers to contextual data about a user, including but not limited to user profile data, recent behavior patterns, or preferences, which is embedded in the prompt sentence to guide the generative model.

The term “constraint condition” refers to a rule or limitation specified in the prompt sentence, such as output length, style, tone, language, or structural requirements of the generated information.

The term “template information” refers to predefined text patterns or structures that are used to construct a prompt sentence by inserting user context information and constraint conditions into fixed or semi-fixed textual forms.

The term “generative model” refers to a computational model, such as a generative AI model, configured to produce new data, including natural language text, in response to input data such as a prompt sentence.

The term “natural language processing function” refers to a capability of a computational model or program to analyze, understand, or generate human language text.

The term “generated information” refers to information, including but not limited to explanatory text or commentary text, produced by the generative model in response to a prompt sentence and customized for a particular user.

The term “explanatory text” refers to generated information that provides a description, clarification, or explanation of content or recommendations for a user.

The term “commentary text” refers to generated information that provides interpretive or evaluative remarks on content, events, or recommendations for a user.

The term “scene information element” refers to a unit of generated information, such as a sentence or a segment, that corresponds to a distinct portion of a video timeline intended to be represented as a separate visual scene.

The term “subtitle information element” refers to text data associated with a scene information element, to be displayed as overlaid text during playback of a corresponding visual scene.

The term “image information” refers to digital image data used as visual content for one or more scenes of short-duration video content.

The term “video clip information” refers to digital video data representing motion images used as visual content for one or more scenes of short-duration video content.

The term “speech synthesis function” refers to a computational function that converts text data into audio data representing artificially generated speech.

The term “audio data” refers to digital data representing sound, including but not limited to speech produced by a speech synthesis function and optionally background audio content.

The term “editing processing” refers to computational operations for arranging and combining visual, textual, and audio data along a time axis, including synchronization, cutting, merging, and overlaying of media elements.

The term “short-duration video content data” refers to a digital media file or data stream representing a video of limited temporal length that includes synchronized visual content, subtitles, and audio for delivery to a user.

The term “storage device” refers to a hardware or virtual resource capable of storing digital data, including video content data and associated metadata.

The term “access identification information” refers to data, such as an identifier, token, or link, that specifies or enables access to corresponding short-duration video content data stored in a storage device.

The term “notification service” refers to a communication infrastructure that delivers notifications, such as push messages, from a server to a user terminal.

The term “communication application” refers to an application program that provides message exchange or information delivery between a server and a user terminal over a communication network.

The term “user terminal” refers to an endpoint device operated by a user, such as a computing device, that receives and presents short-duration video content data or related notifications.

The term “viewing history information” refers to data indicating how a user has consumed short-duration video content, including but not limited to watch duration, completion status, replay count, or playback interactions.

The term “reaction information” refers to data indicating explicit or implicit user responses to short-duration video content, including but not limited to ratings, feedback inputs, selection actions, or interaction events.

The term “weighting information” refers to data representing relative importance or priority assigned to different fields of interest, content types, or topics for a user, used in constructing or modifying prompt sentences.

The term “scene unit” refers to a segment of short-duration video content corresponding to one scene information element or a combination of such elements, treated as a unit for visual and temporal editing.

The term “background video” refers to visual content, including still or moving images, arranged behind or in conjunction with subtitles or other foreground elements within a scene of short-duration video content.

The term “text display position” refers to spatial coordinates or layout parameters indicating where subtitle information or other text is to be rendered within a video frame.

The term “subtitle display timing” refers to time-based parameters indicating when subtitle information is to appear and disappear during playback of video content.

The term “scene switching timing” refers to time-based parameters indicating when a transition from one scene unit to another occurs during playback of video content.

The term “time information of the audio data” refers to temporal parameters, including but not limited to timestamps, duration, or phoneme timing, associated with audio data generated by the speech synthesis function.

The term “closed-loop computation pipeline” refers to a sequence of computational processes in which outputs, including viewing history information and reaction information, are fed back into earlier stages such as feature extraction and prompt sentence construction to iteratively refine subsequent processing.

In one embodiment, a server implements the system as a network-connected computing apparatus including at least one processor, a main memory, a non-volatile storage device, and a network interface. The server uses general-purpose hardware such as multi-core CPUs and graphics processing units, and executes an operating system and middleware to run software components written in a programming language such as a scripting language or a compiled language. The server further connects to a database management system, an in-memory cache, and one or more external application programming interfaces over a communication network.

The server implements a data acquisition module that communicates with external information processing apparatuses and external information providing apparatuses. The server uses communication libraries over a transport protocol to send authenticated requests to external services that maintain behavior history information and location information, such as web access log services, social networking services, and location information services. The server receives response messages encoded in structured formats and parses each response into internal data records. The server normalizes each record into a unified schema having fields such as user identifier, timestamp, content text, content type, and location coordinates.

The server stores the normalized records in a persistent data store, for example in relational tables and column-oriented tables optimized for analytical queries. The server thereby constructs a behavior data set that integrates behavior history information and location information for each user.

The server implements a feature extraction module that operates on the behavior data set. The server loads text content from the behavior data set and applies character information processing algorithms implemented with natural language processing libraries. The server performs tokenization, lowercasing, stop-word removal, and language detection to obtain normalized text sequences. The server then applies a feature extraction algorithm that computes feature quantities. In one embodiment, the server uses a term frequency-inverse document frequency scheme to compute topic weights per user and applies a clustering algorithm to group frequently occurring terms into fields of interest. In another embodiment, the server feeds the normalized text into a pre-trained transformer-based encoder neural network to obtain embedding vectors, and applies a dimensionality reduction algorithm to derive compact feature quantities that represent user preferences and behavior tendencies.

The server calculates, for each user, feature quantities such as a distribution over content topics, a temporal activity histogram, a distribution of visited location clusters, and an engagement score for different content categories. The server aggregates these quantities into user profile data stored in a dedicated profile table. The server updates the user profile data incrementally when new behavior records are added to the behavior data set. This structured representation of user interests and tendencies allows the server to perform subsequent computations using fixed-size vectors and standardized fields, which improves cache locality and reduces processing time during feature retrieval and prompt construction.

The server implements a prompt construction module that uses the user profile data to generate a prompt sentence for a generative AI model. The server maintains one or more template information records defining prompt structures, including placeholders for generation instruction text, user context information, and constraint conditions. The server retrieves the relevant user profile data, including top fields of interest, recent behavior summaries, and preferred content length, and populates the placeholders accordingly.

In one example, the server constructs a prompt sentence in natural language as follows:

“Based on the following user context:
Recent searches: healthy recipes, 30-minute workouts, low-carb snacks.
Recent social media posts: salad photos, comments about running in the park.
Active time: 6:00-8:00 AM.

Generate today's recommended health and fitness information.

Output a script suitable for a 45-second short video, with 3-5 short sentences, including one breakfast suggestion and one 15-minute exercise tip.”

In another example, the server constructs a prompt sentence as:

“Using the user's last 7 days of web search history and social media posts, summarize three topics that the user is most interested in and generate a 60-second script explaining these topics in simple language for a beginner.”

The server can further adapt the prompt sentence based on weighting information derived from viewing history information and reaction information. For example, if the user exhibits strong engagement with fitness-related content and weak engagement with finance-related content, the server increases the weight of fitness topics and reduces or omits finance topics in subsequent prompt sentences.

The server implements the generative AI model as a neural network-based language model, for example a transformer architecture having multiple self-attention layers, feed-forward layers, and layer normalization. The server stores model parameters, including weight matrices and bias vectors, in memory and executes the forward pass using optimized linear algebra libraries and hardware acceleration on GPUs. The generative AI model has been trained beforehand using a large corpus of text data through gradient-based optimization, where the server or a training cluster minimized a loss function, such as cross-entropy between predicted and actual token distributions, by iteratively updating model weights according to a backpropagation algorithm and a stochastic gradient descent variant. During training, the system used data augmentation techniques such as random masking and shuffling of input segments to improve generalization.

During inference, the server inputs the constructed prompt sentence as tokenized text into the generative AI model and performs autoregressive decoding with parameters such as temperature, top-k, and maximum output length. The server uses a constrained decoding strategy to enforce certain structure constraints, such as a limited number of sentences or a specific ordering of elements (for example, introduction, main recommendations, conclusion).

This structured decoding reduces the need for downstream post-processing and improves determinism of the generation process. The server outputs generated information in the form of an explanatory text or commentary text customized for the user.

The server records the generated information into a recommendation storage table together with metadata including the user identifier, the prompt sentence used, the model version, and timestamps. The server then invokes a segmentation module that divides the generated information into scene information elements and subtitle information elements. The server applies rule-based segmentation, for example splitting on sentence boundaries, bullet markers, or explicit scene tags inserted by the generative AI model. The server assigns a scene identifier, an estimated display duration, and a text snippet to each scene information element.

The server implements a media generation and editing module that creates short-duration video content data from the scene information elements and subtitle information elements.

The server retrieves, for each scene, relevant visual assets from an asset repository or triggers image generation using a generative image model configured, for example, as a diffusion-based neural network or a generative adversarial network. The generative image model produces images that correspond to the text semantics of the scene information element by encoding the text into an embedding space and conditioning the generation process on that embedding. Alternatively, the server selects pre-existing video clip information from a media database based on similarity between textual tags and the scene text.

The server invokes a speech synthesis function implemented by a text-to-speech engine. The server converts the full script or per-scene scripts into phoneme sequences using a linguistic front-end, predicts prosody parameters such as pitch and duration using a prosody model, and generates waveform samples using a neural vocoder, for example a convolutional or autoregressive model trained to reconstruct waveforms from mel-spectrograms. The server outputs audio data in a compressed format and computes time information, including exact timestamps for phoneme and word boundaries.

The server aligns subtitle display timing and scene switching timing with the time information of the audio data. The server calculates, for each subtitle information element, a start time and an end time based on the positions of the corresponding words in the synthesized speech. The server determines scene switching timing so that visual transitions occur at natural boundaries in the narration, reducing perceptual discontinuity. The server then uses a video editing library or engine to programmatically compose the short-duration video content data by placing background video, overlaying subtitle text at predetermined text display positions, and mixing the audio track on a shared time axis. This automated synchronization process reduces jitter and misalignment typical of manually scripted pipelines and improves the technical quality of the multimedia output.

The server stores the short-duration video content data in a storage device, such as object storage, and generates access identification information such as a unique identifier or link.

The server associates access identification information with the corresponding user identifier and logged generation parameters. The server then interacts with a notification service or a communication application to deliver the content to the user terminal. The server sends a push message containing the access identification information or, in some embodiments, the video content itself to the user terminal over a network. This delivery is performed using secure communication protocols and device-specific push notification mechanisms.

The terminal operates as a user endpoint device that receives notifications from the server and obtains the short-duration video content data. The terminal executes a client application that interprets the notification payload, requests the video content from the server storage using the access identification information, and plays back the short-duration video content data using local media playback hardware. The terminal decodes video and audio streams and overlays subtitles at the positions and times specified by the server's editing metadata. The terminal optionally collects viewing history information, such as playback duration, completion status, and user-triggered events like pause or replay, and sends this information back to the server.

The user interacts with the system primarily through the terminal. The user may give or revoke consent for data collection, select preference settings such as preferred content categories or video length, and provide explicit reaction information, for example by rating or tagging the content. The user's actions become part of the viewing history information and reaction information, which the terminal reports to the server.

The server integrates the viewing history information and reaction information into the behavior data set. The server extends the behavior data set schema to include fields for watch time, completion ratio, replay count, reaction labels, and timestamps of interactions. The server processes these logs with the feature extraction algorithm, calculating, for example, per-topic engagement scores and decay-weighted interest measures. The server updates the weighting information used in prompt construction by increasing the weights of topics associated with high engagement and decreasing weights for topics associated with low engagement. The server then reconfigures the prompt sentence templates to reflect these weights, for example by inserting instructions such as “prioritize fitness and health topics over finance topics” or by modifying constraint conditions for output length.

This closed-loop feedback mechanism directly modifies the computational behavior of the generative AI model invocation and the media generation pipeline. Because the server stores and processes all intermediate data structures-behavior data set, user profile data, prompt sentences, generated information, scene information elements, and viewing history information—in an integrated architecture, the system reduces redundant computations and repeated format conversions. The server can cache feature vectors and precomputed embeddings, thereby avoiding recomputation for each new request. The server also reduces network traffic by computing scene segmentation and subtitle timing server-side, so the terminal receives a single, fully synchronized media asset, instead of having to fetch and assemble multiple assets.

From a technical perspective, the described configuration improves the operation of the server and the computer network. The structured behavior data set and user profile data allow the server to query relevant features in sublinear time using indexed tables and in-memory caches, which enhances throughput. The use of feature extraction algorithms and learned embeddings allows the server to represent complex behavior patterns in low-dimensional vectors, which reduces memory footprint and accelerates matrix operations executed by the generative AI model. The prompt construction mechanism, which injects explicit constraint conditions and structured context, reduces the search space during autoregressive decoding and lowers the number of tokens generated for a given utility, improving inference latency and computational efficiency.

Further, the explicit segmentation of generated information into scene information elements and precise alignment of subtitles and scenes with audio time information reduce synchronization errors and re-encoding operations. The server can reuse visual assets across different users and scripts by separating content abstraction (scene information elements) from media instantiation (video clip information). This modularity yields better cache utilization of media assets and diminishes storage and bandwidth requirements. The system is therefore not a mere automation of human editorial work; rather, it employs non-conventional data structures, model-inference control methods, and synchronization algorithms that are specifically designed to exploit the capabilities and constraints of modern computing hardware.

In another embodiment, the server may deploy multiple generative AI models, including a first model specialized in summarization and a second model specialized in style adaptation.

The server can pipeline these models such that the first model compresses behavior history information into a concise narrative, and the second model reformats the narrative into a script suited for short-duration video. The server may also adjust hyperparameters such as temperature or length penalty based on the fields of interest and the user's prior tolerance for novelty, as inferred from reaction information. This multi-model pipeline enhances generation precision and reduces the need for repeated calls to a single, general-purpose model.

In yet another embodiment, the server trains the generative AI model or fine-tunes a base model using a training set composed of past prompt sentences, generated information, and subsequent viewing history information. The server defines a custom loss function that combines a language modeling objective with a feedback-based objective that penalizes outputs associated with low engagement and rewards outputs associated with high engagement. During training, the server performs backpropagation over this combined loss, thereby adjusting model weights to produce content that is not only linguistically coherent but also more likely to match user engagement patterns. This training process changes the internal representation space of the model to better align with the system's closed-loop objective, which is a technical improvement in the operation of the model within this particular system.

Alternative embodiments may vary individual components while maintaining the overall architecture. For instance, the server may replace the transformer-based generative AI model with a recurrent neural network-based model in resource-constrained environments, or may offload image generation to a dedicated image-processing apparatus. The feature extraction algorithm may employ different classifiers, such as convolutional neural networks or gradient boosting machines, without departing from the concept of computing feature quantities from the behavior data set. The speech synthesis function may be realized by a traditional concatenative TTS engine or by a fully neural TTS pipeline, while still emitting audio data with associated time information for synchronization.

By integrating these computational modules and data flows in the described manner, the server achieves improved processing speed, reduced synchronization errors, more accurate personalization, and lower communication overhead. The system's design, centered on explicit feature extraction, structured prompt sentence construction, model-inference control, and precise multimedia synchronization, results in a specific improvement in computer functionality and networked multimedia delivery, beyond simply performing intellectual tasks on a computer.

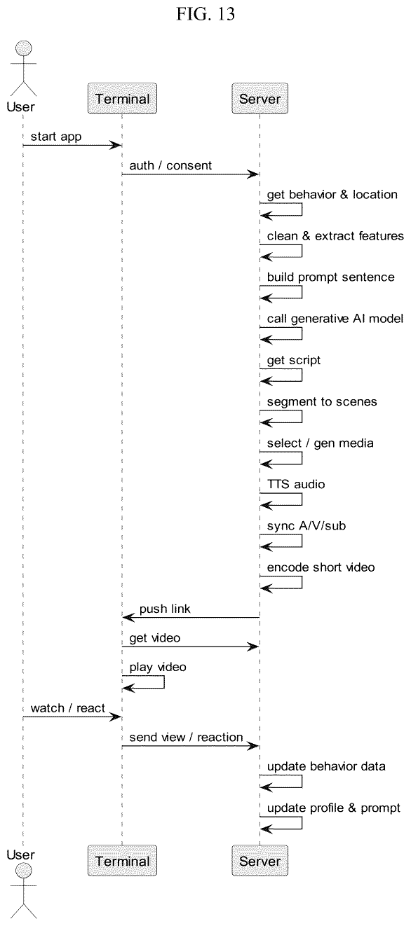

The following describes the processing flow using FIG. 13.

### Step 1:

The server acquires raw behavior data.

The server receives, as input, user identifiers and authentication tokens obtained through previous user registration and consent procedures. The server sends authenticated requests to external information processing apparatuses and external information providing apparatuses to obtain behavior history information (such as search queries, page views, messages, and social posts) and location information (such as coordinates or region identifiers). The server uses communication protocols to transmit these requests and receives response messages in structured formats. The server parses the responses, normalizes individual records into a unified internal schema with fields such as user ID, timestamp, content text, content type, and location, and stores the normalized records in a persistent storage. The server outputs a behavior data set that aggregates all normalized records for each user.

### Step 2:

The server preprocesses text content and filters the behavior data set.

The server reads, as input, the behavior data set generated in Step 1. The server applies character information processing algorithms, including tokenization, lowercasing, stop word removal, and language detection, to text fields such as search queries and social posts. The server removes noise records that lack sufficient text or fall outside a predefined time window. The server performs these operations using natural language processing libraries and writes back cleaned records into an intermediate table. The server outputs a cleaned behavior data set in which each record includes normalized text and validated metadata.

### Step 3:

The server extracts feature quantities and constructs user profile data.

The server takes, as input, the cleaned behavior data set from Step 2. The server applies a feature extraction algorithm to compute feature quantities that represent user interests and behavior tendencies. For example, the server calculates term frequency-inverse document frequency scores for keywords, groups keywords into topic categories, and computes the frequency of each category per user. The server also aggregates timestamps to build a temporal activity histogram and clusters location information to identify frequently visited areas. The server combines these derived values into a fixed-length feature vector for each user and stores the vectors and associated information in a user profile data storage. The server outputs user profile data that summarizes each user's fields of interest and behavior tendencies.

### Step 4:

The server constructs a prompt sentence for a generative AI model.

The server receives, as input, the user profile data generated in Step 3 and one or more prompt templates stored in configuration storage. The server selects a template based on system rules, such as desired video length or content category, and populates placeholders in the template with user context information derived from the feature quantities, for example top interest topics, typical active time, and recent behavior examples. The server concatenates generation instruction text, user context information, and constraint conditions into a single text string.

The server then performs minor formatting, such as inserting line breaks or bullet markers, to create a well-structured prompt sentence. The server outputs the constructed prompt sentence associated with the corresponding user identifier.

### Step 5:

The server executes a generative AI model to produce customized text.

The server uses, as input, the prompt sentence from Step 4 and model configuration parameters such as maximum output length and temperature. The server tokenizes the prompt sentence into token IDs and feeds them into a generative AI model implemented as a neural network, for example a transformer-based language model. The server performs a forward pass through multiple layers of the model to compute token probability distributions and applies an autoregressive decoding process to generate output tokens. The server converts the output tokens back into text, resulting in generated information that includes an explanatory text or commentary text customized for the user. The server stores the generated information together with the prompt sentence and associated metadata. The server outputs the generated information as a structured script.

### Step 6:

The server segments the generated information into scene units and subtitles.

The server takes, as input, the generated information obtained in Step 5. The server applies segmentation rules, such as splitting at sentence boundaries, bullet markers, or cue phrases, to divide the text into discrete scene information elements. The server assigns an estimated display duration to each scene based on sentence length or a configured duration per sentence.

The server duplicates the text content of each scene information element as a subtitle information element and may perform line wrapping to fit display constraints. The server stores the scene information elements, subtitle information elements, scene identifiers, and estimated durations in a scene structure storage. The server outputs a scene structure that defines the textual and temporal units for subsequent media generation.

### Step 7:

The server selects or generates visual media for each scene.

The server receives, as input, the scene information elements and associated metadata from Step 6. For each scene, the server analyzes the text to extract keywords and topic tags, and then queries an asset repository for matching image information or video clip information.

When no suitable asset is found, the server can call an image generation module or external image generation service, providing the scene text as a condition. The server thus obtains, for each scene, at least one corresponding visual media resource. The server stores identifiers of the selected or generated media resources linked to the scene identifiers. The server outputs a media selection mapping that associates each scene with its visual content.

### Step 8:

The server generates narration audio using a speech synthesis function.

The server uses, as input, the full generated script from Step 5 or per-scene text segments from Step 6. The server sends the text to a speech synthesis engine, which converts the text to phoneme sequences, predicts prosodic features, and generates waveform samples. The server specifies voice characteristics and language parameters when calling the speech synthesis function. The speech synthesis engine returns audio data and time information such as word or phoneme alignment timestamps. The server stores the audio data in media storage and logs the timing metadata. The server outputs an audio track and associated timing data for the entire script or for each scene.

### Step 9:

The server synchronizes subtitles, scenes, and audio on a time axis.

The server takes, as input, the scene structure from Step 6, the media selection mapping from Step 7, and the audio timing data from Step 8. The server maps each subtitle information element to a time interval within the audio track by aligning subtitle words with word timestamps provided by the speech synthesis function. The server assigns start and end times to each scene information element based on the combined durations of its subtitles and associated audio segments. The server determines scene switching timing at points where the narration naturally pauses, and it calculates the positions for text overlay within each frame for subtitle display. The server outputs a time-aligned storyboard, specifying, for each time interval, the active visual resource, subtitle text, display position, and corresponding segment of the audio track.

### Step 10:

The server composes short-duration video content data.

The server uses, as input, the time-aligned storyboard from Step 9 and the underlying media resources, including image information, video clip information, and audio data. The server invokes a media editing engine that processes the storyboard sequentially, loading the specified media assets, placing them on a timeline, and overlaying subtitles at the indicated positions and times. The server blends transitions between scenes, encodes the combined visual frames and audio track into a compressed video format, and produces short-duration video content data. The server stores the completed video file in a storage device and generates access identification information such as a unique path or token. The server outputs the stored short-duration video content data and its access identification information.

### Step 11:

The server delivers the video content to the terminal.

The server receives, as input, the access identification information and user identifier from Step 10 and a delivery configuration that specifies a notification service or communication application to be used. The server constructs a notification payload containing at least the access identification information and an optional textual description, and sends the payload through a notification service interface to the terminal. In some cases, the server also provides a direct download URL or streams the video content. The server records the delivery event in a log. The server outputs a delivery result status indicating whether the notification was successfully queued or transmitted.

### Step 12:

The terminal retrieves and plays back the short-duration video content.

The terminal receives, as input, the notification payload from the server as delivered in Step 11. The terminal extracts the access identification information and uses it to request the short-duration video content data from the server's storage endpoint. The terminal downloads the video file via a network protocol and stores it temporarily in local memory. The terminal then invokes its media playback component to decode the video and audio streams, displays the video frames on the screen, and renders the audio through speakers or headphones. The terminal reads timing metadata embedded in the video to display subtitles at the predetermined positions and times. The terminal outputs a playback session during which the user can view and listen to the personalized short-duration video content.

### Step 13:

The terminal and the user generate viewing history information and reaction information.

The user interacts with the video player on the terminal by actions such as watching, pausing, seeking, rewatching, or closing the video. The terminal records, as output, viewing history information that includes playback duration, completion ratio, timestamps of user interactions, and replay count. The user may also provide explicit reaction information, such as pressing like buttons or selecting feedback options. The terminal captures these reactions and associates them with the video identifier and user identifier. The terminal then sends the viewing history information and reaction information as input to the server through a communication channel.

### Step 14:

The server integrates feedback into the behavior data set and updates user profile data.

The server accepts, as input, the viewing history information and reaction information from Step 13. The server converts this feedback into records that conform to the behavior data set schema, for example by treating each viewing event as a behavior record with fields such as content category, engagement score, and reaction labels. The server appends these records to the behavior data set and re-executes the feature extraction algorithm, now including the new feedback data. The server updates the feature quantities by adjusting topic weights based on engagement, recalculating activity distributions, and refining estimates of user preferences.

The server stores the updated feature vectors in the user profile data storage and logs the update. The server outputs revised user profile data that incorporates both past behavior and recent feedback.

### Step 15:

The server adapts future prompt sentences based on updated weights.

The server receives, as input, the revised user profile data from Step 14 and any defined rules for weighting topics or content types. The server computes updated weighting information by increasing weights for topics associated with high engagement metrics and decreasing weights for topics associated with low engagement or negative reactions. The server modifies prompt templates or dynamically inserts clauses into prompt sentences to reflect the new weighting information. For example, the server may insert phrases such as “prioritize fitness and health topics” or adjust constraint conditions that control output length and focus. The server stores the adapted templates and the computed weighting information. The server outputs new prompt sentences for use in subsequent executions of the generative AI model, thereby closing the feedback loop and continuously refining the personalization process.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content recommendation and advertising delivery systems primarily rely on coarse-grained user segmentation and static rule-based engines. In such systems, a server typically aggregates basic user activity logs and applies simple matching logic or pre-defined templates to select content. This architecture has several technical limitations. First, the server cannot dynamically and precisely adapt output content structure, modality, and timing to rapidly changing user interests and emotional states, because the system lacks an integrated mechanism for jointly modeling fine-grained user behavior, affective context, and downstream content generation parameters. Second, existing systems generally invoke generative AI models in an ad hoc manner, without a structured feedback loop that links generated prompt sentences, user engagement signals, and subsequent prompt refinement. As a result, the server cannot systematically optimize prompt design or content structure on a per-user basis, leading to inefficient use of computational resources and sub-optimal personalization quality.

Third, typical systems treat text generation and visual generation as independent pipelines. The server does not convert generated text into structured content data that explicitly encodes scene information, explanatory information, and visual element information linked with time information. Consequently, the server cannot automatically construct individualized storyboards or control the number of scenes, per-scene duration, and scene order in a principled way for each user. Fourth, notification delivery and user feedback are often loosely coupled with the generative pipeline. The server may push a generic notification with a static link, but it does not tightly integrate viewing status information, operation history information, and reaction information into user profile updates and future content generation control. This results in a technically inefficient loop where the system fails to exploit rich client-side telemetry to improve the behavior of the generative AI models and the surrounding orchestration logic.

Accordingly, there is a need for an improved computer-implemented system in which a processor: (i) acquires heterogeneous user behavioral information and emotion-related input in a unified manner; (ii) processes such information using information analysis algorithms to derive an enriched user profile that includes interest categories, behavioral characteristics, and an emotional state; (iii) programmatically generates structured prompt sentences as control instructions to one or more generative AI models; (iv) transforms text outputs from the generative AI models into structured content data including scene and visual element layers; (v) automatically builds and renders individualized short-duration video content under explicit timing control; and (vi) integrates a closed-loop feedback mechanism that updates both the user profile and future prompt sentence generation conditions based on measured user engagement. By improving how the server represents user context, controls generative AI models, and orchestrates content generation and delivery, such a system can enhance the efficiency, adaptability, and technical performance of computer-implemented personalization and media generation processes.

The specific processing by the specific processing unit 290 of the data processing device 12 in Application Example 2 is realized by the following means.

The present invention provides a server comprising a processor and a memory storing instructions which, when executed by the processor, cause the processor to collect user behavioral information and user input information via a network from an information acquisition device or an information acquisition program, process the collected information by an information analysis algorithm to generate a user profile including an interest category, a behavioral characteristic, and an emotional state of a user, generate, on the basis of the user profile, a prompt sentence including constraint conditions defining at least an output format, a writing style, a length, and a usage purpose, and configure the prompt sentence as a prompt sentence to be input to a generative AI model, obtain text information output from the generative AI model in response to the prompt sentence and edit the text information into structured content data by dividing the text information into scene information, explanatory information, and visual element information, generate, on the basis of the structured content data, a further prompt sentence including the visual element information for an image-generation generative AI model, input the further prompt sentence to the image-generation generative AI model and obtain image data output therefrom, generate, on the basis of the text information and the image data, a storyboard of short-duration visual content by associating the text information and the image data with time information and automatically generate a video file having a predetermined duration by using a video generation program, generate notification data including identification information and reference location information of the generated video file and transmit the notification data to a user terminal via a communication interface that uses a notification function of a communication application or an information providing application, and obtain viewing status information, operation history information, and reaction information of the video transmitted from the user terminal and update the user profile and generation conditions of a future prompt sentence on the basis of an obtained result. This enables the server to implement an end-to-end, feedback-driven control loop in which user behavior and emotional context are continuously reflected in dynamically constructed prompt sentences, structured content data, and individualized short-duration video content, thereby improving the technical efficiency, adaptability, and personalization quality of computer-implemented content generation and delivery processes.

The term “user behavioral information” refers to information indicating actions or activities performed by a user in an information environment, including at least search history, communication history, browsing history, application usage history, and location information acquired from one or more devices.

The term “user input information” refers to information that is explicitly provided by a user through an input interface, including at least text data and audio data that can be used as a basis for estimating an emotional state of the user.

The term “information acquisition device” refers to a hardware component or a combination of hardware components configured to acquire user behavioral information or user input information, including at least a terminal device, a sensor module, or a communication interface.

The term “information acquisition program” refers to software executed on a device and configured to monitor, collect, and transmit user behavioral information or user input information to a server via a network.

The term “information analysis algorithm” refers to a computational procedure executed by a processor to process collected information, including at least a data preprocessing procedure, a feature extraction procedure, and a pattern analysis procedure based on statistical analysis, machine learning, or rule-based logic.

The term “natural language processing” refers to a set of computational techniques for analyzing and processing human language data, including at least tokenization, parsing, entity extraction, topic detection, and text classification.

The term “machine learning” refers to a computational technique in which a model is trained on data to infer patterns or make predictions, including at least supervised learning, unsupervised learning, and reinforcement learning applied to user data.

The term “emotion analysis algorithm” refers to a computational procedure for estimating an emotional state of a user from text data or audio data, including at least sentiment analysis, affect classification, and mapping of numerical scores to discrete emotion labels.

The term “emotional state” refers to a condition representing an affective aspect of a user, including at least states such as joy, sadness, anger, fear, neutrality, or combinations or degrees thereof, as determined by the emotion analysis algorithm.

The term “interest category” refers to a classification label representing a thematic domain in which a user has interest, such as outdoor activities, entertainment, sports, or finance, derived from analysis of the user behavioral information.

The term “behavioral characteristic” refers to a feature representing a pattern of user activity, including at least frequency, timing, or type of actions taken by the user within a given time period.

The term “user profile” refers to a data structure stored in a memory and associated with a user, the data structure including at least one interest category, at least one behavioral characteristic, and at least one emotional state.

The term “generative AI model” refers to an artificial intelligence model configured to generate output content such as text, images, or audiovisual elements in response to an input prompt sentence, based on parameters learned from training data.

The term “prompt sentence” refers to a text instruction that specifies one or more constraints or conditions for content generation by a generative AI model, including at least an output format, a writing style, a length, a usage purpose, or a content theme.

The term “text information” refers to character-based data output from a generative AI model in response to a prompt sentence, including at least narratives, descriptions, scripts, explanations, or advertising messages.

The term “structured content data” refers to a representation of text information in which the text information is divided and organized into predefined elements including at least scene information, explanatory information, and visual element information.

The term “scene information” refers to a portion of structured content data representing a unit of presentation in visual content, including at least a scene identifier, a scene description, and associated time information.

The term “explanatory information” refers to a portion of structured content data representing text that explains, narrates, or supplements a scene, including at least captions, voice-over scripts, or on-screen texts.

The term “visual element information” refers to a portion of structured content data specifying visual features to be included in a scene, including at least object types, backgrounds, styles, or atmosphere descriptors used to guide image or video generation.

The term “image-generation generative AI model” refers to a generative AI model configured to output image data in response to a prompt sentence specifying visual elements, styles, or scene descriptions.

The term “image data” refers to digital data representing at least one image or a sequence of images suitable for inclusion in visual content, as generated by an image-generation generative AI model or other image generation process.

The term “storyboard” refers to a structured representation of visual content, in which scenes, associated image data, explanatory information, and time information are arranged in a sequence defining the configuration of a video.

The term “short-duration visual content” refers to visual media content whose playing time is limited to a relatively short period, including at least a video having a duration on the order of several tens of seconds.

The term “time information” refers to data indicating a temporal relationship in visual content, including at least a start time, an end time, or a duration associated with each scene or visual element.

The term “video generation program” refers to software executed by a processor and configured to compose image data, text information, and time information into a video file with a predetermined duration.

The term “video file” refers to a digital file containing encoded audiovisual data suitable for playback by a media player, the file including at least visual frames and associated timing information.

The term “notification data” refers to data generated for delivery to a user terminal and including at least identification information of a video file, reference location information for accessing the video file, and optionally a title, a summary, or a thumbnail.

The term “identification information” refers to data that uniquely or distinctively identifies a video file or content item in a system, including at least an identifier, a uniform resource locator, or a content key.

The term “reference location information” refers to data indicating a storage location or access endpoint for a video file, including at least a network address, a resource path, or a content delivery address.

The term “communication interface” refers to a hardware or software component configured to transmit and receive data between a server and one or more user terminals, including at least protocol handling, addressing, and session management functions.

The term “communication application” refers to an application program executed on a user terminal and configured to provide messaging or notification functions, including at least a chat application, a social communication application, or a push notification client.

The term “information providing application” refers to an application program executed on a user terminal and configured to provide information retrieval or content browsing functions, including at least a search application or a content aggregation application.

The term “user terminal” refers to an electronic device operated by a user and capable of communicating with a server via a network, including at least a smartphone, a tablet, a personal computer, or a wearable device.

The term “viewing status information” refers to information indicating how a user has viewed a video, including at least playback start, playback end, playback duration, pause operations, or replay operations.

The term “operation history information” refers to information indicating control or navigation actions performed by a user in relation to a video or a notification, including at least taps, clicks, scrolls, skips, or seek operations.

The term “reaction information” refers to information indicating an explicit or implicit response of a user to content, including at least ratings, reactions, comments, shares, or link selections.

The term “generation conditions of a future prompt sentence” refers to parameters or control information used when constructing prompt sentences for subsequent invocations of a generative AI model, the parameters including at least content type, detail level, tone, length, and emphasis based on updated user profile data and engagement data.

In one or more embodiments, a system includes a server, one or more terminals, and one or more networks connecting them. The server includes at least one processor, a main memory, a non-volatile storage device, and a communication interface. The terminal includes an input device, a display device, a communication interface, and optional sensor devices such as a position sensor and a microphone. The system is configured so that the server executes computer programs stored in the memory to perform the functions described below.

The server uses commercially available general-purpose hardware, such as multi-core central processing units (CPUs) and optional graphics processing units (GPUs). The server uses a storage subsystem, such as a relational database management system or a document database, to store user profiles, content data, model parameters, and logs. The server uses a communication stack, such as a transmission control protocol and an Internet protocol, to exchange data with the terminals and with external information sources.

In one embodiment, the terminal is a smartphone or a tablet computer running an operating system that supports a communication application and an information providing application.

The terminal has a browser, a messaging application, and an input framework for capturing user text input and voice input. The terminal includes a software module that logs user behavioral information and user input information and transmits such information to the server.

In one embodiment, the terminal periodically acquires search history, communication history, and application usage events from an operating system logging interface. The terminal acquires location information from a position sensor. The terminal acquires user text input from a text input interface of a communication application, and acquires audio data from a microphone via an audio capture interface. The terminal converts the acquired information into a structured data record including at least a user identifier, a timestamp, a data type, and a payload. The terminal transmits the structured data record to the server by using a secure transport protocol.

The server receives the structured data record through an application-layer programming interface. The server validates the record and stores the record in a database. The server uses different tables or collections for different types of information, such as search logs, message texts, location logs, and emotion-related input texts. The server thereby accumulates user behavioral information and user input information over time.

The server defines a user profile data structure in the database. The user profile data structure includes fields for an interest category list, a behavioral characteristic vector, and an emotional state vector. The interest category list contains identifiers corresponding to semantic domains such as outdoor activities, entertainment, sports, or finance. The behavioral characteristic vector contains numerical values representing, for example, frequency of certain activities, time-of-day distributions, and recency scores. The emotional state vector contains one or more values representing probabilities or intensities of discrete emotion classes.

The server executes an information analysis algorithm implemented as one or more software modules written in a general-purpose programming language. The server uses a natural language processing library to tokenize and parse user text, such as messages or search queries. The server uses a trained classifier to map words and phrases to topic labels and interest categories. In one embodiment, the server uses a multilayer neural network classifier that receives a sequence of token embeddings and outputs a probability distribution over interest categories. The server stores the classifier parameters in memory and executes the classifier on the CPU or GPU.

The server performs machine learning to derive a behavioral characteristic vector. The server defines a feature space including features such as daily count of searches in each category, total viewing time per category, and frequency of visits to certain types of locations. The server aggregates user behavioral information into this feature space over a configurable time window. The server applies a clustering algorithm or a regression model to obtain behavioral characteristics. This processing yields a compressed representation of user behavior that can be evaluated efficiently in subsequent content generation.

The server performs emotion analysis on user input information. For text data, the server uses a sentiment analysis model that converts tokens into embeddings and passes them through a deep neural network, such as a bidirectional recurrent network or a transformer network, to produce an emotion vector. For audio data, the server first executes a speech-to-text model, such as an encoder-decoder neural network with attention, to obtain text, and then applies the same text-based sentiment model. The server maps the emotion vector to a discrete emotional state, such as joy or sadness, by selecting the highest-probability label or by applying threshold logic.

The server updates the user profile in the database with the interest category list, behavioral characteristic vector, and emotional state vector. The server may weight newer information more heavily than older information to reflect recent changes in user behavior and mood. By storing this data in a structured profile, the server can quickly retrieve relevant parameters when constructing a prompt sentence.

The server constructs a prompt sentence for a generative AI model. The server retrieves the user profile and determines a content generation purpose, such as providing explanatory content or advertising content. The server reads the interest category list and the emotional state vector and computes control parameters including an output format indicator, a writing style indicator, a target length, and a usage purpose indicator. The server then concatenates these parameters into a natural language instruction.

In one example, when the server determines that the user is highly interested in outdoor activities and that the emotional state is joy, the server constructs a prompt sentence such as:

“You are a generative AI model. The user is highly interested in outdoor activities and camping. The user's current emotion is joy. Generate a 400-word explanation of the latest outdoor gear and essential camping items in a friendly, informative tone.”

In another example, when the server detects that the user is sad, the server constructs a prompt sentence such as:

“You are a generative AI model. The user feels sadness after a difficult day at work. Generate a short comforting text with supportive words and three simple relaxation tips. Use gentle and empathetic language.”

In a further example for advertising content, the server constructs a prompt sentence such as:

“You are a generative AI model specialized in advertising copy. The user's emotion is happy and the user likes outdoor gear. Generate a 30-second ad script for new lightweight camping gear that emphasizes fun weekend trips with friends. Include a catchy slogan and a call to action.”

The server may store template fragments for different purposes and dynamically fill in slots in the template with categories and emotions. The server also stores the prompt sentence in a log table together with a user identifier and generation parameters. This allows later analysis of which prompt structures produce favorable user engagement.

The server invokes a text-type generative AI model. In one embodiment, the generative AI model is implemented as a transformer-based neural network with multiple self-attention layers, layer normalization, and feed-forward sub-layers. The server stores model parameters in the memory or accesses them via a model hosting service. The server encodes the prompt sentence into tokens and feeds the token sequence to the generative AI model. The model outputs a sequence of token probabilities; the server uses sampling or beam search to select a sequence of tokens representing text information.

The server obtains the generated text information and converts it into structured content data.

The server identifies logical segments, such as scenes or paragraphs, by detecting sentence boundaries or specific markers in the output. The server applies natural language processing to detect visual elements, such as objects, locations, and actions. The server then stores the text information as structured content data including scene information, explanatory information, and visual element information. For each scene, the server stores a scene identifier, one or more lines of explanatory information, and a set of visual element descriptors.

The server generates a further prompt sentence for an image-generation generative AI model. For each scene, the server assembles visual element information into a descriptive instruction. For example, when the explanatory information describes “a modern mountain campsite at sunset with lightweight tents and backpacks,” the server constructs a prompt sentence such as: “Generate a photorealistic image of a modern mountain campsite at sunset with lightweight tents and backpacks, suitable for an outdoor gear advertisement.”

For a relaxation-related scene, the server may construct a prompt sentence such as:

“Generate a calm, minimal illustration of a person relaxing on a sofa in a softly lit living room, suitable for a wellness and relaxation video.”

The server inputs the prompt sentence to an image-generation generative AI model. In one embodiment, the image-generation generative AI model uses a diffusion architecture that iteratively denoises a latent representation to produce an image. The server runs the diffusion process on a processor or a graphics processor and obtains image data fields that may include a pixel matrix and metadata. The server associates each generated image with the corresponding scene identifier in the structured content data.

The server generates a storyboard. The server determines the number of scenes to include in a short-duration visual content item, the display time of each scene, and the scene order. The server may compute these parameters based on the behavioral characteristic vector and the emotional state vector in the user profile. For example, when the behavioral vector indicates short attention spans, the server may shorten the per-scene duration and reduce the total number of scenes. When the profile indicates a strong preference for detailed explanations, the server may increase the number of scenes and allocate more text per scene.

The server assigns time information to scenes by calculating start times and end times. The server thereby creates a storyboard data structure that maps each scene identifier to an image reference, a text overlay, and a time interval. The server uses a video generation program to render the storyboard into a video file. The video generation program reads the storyboard, loads images from storage, overlays text as subtitles or captions, and encodes frames into a compressed video format using a codec.

The server stores the generated video file in a content storage component and records identification information and reference location information, such as a content identifier and a network resource locator. The server then constructs notification data that includes the identification information, the reference location information, and optionally a title or a summary derived from the text information. The server transmits the notification data to the terminal via the communication interface of a communication application or an information providing application.

The terminal receives the notification data by using a messaging protocol and displays a notification on the display device. When the user selects the notification, the terminal opens a playback screen and requests the video file from the content storage component using the reference location information. The terminal streams or downloads the video file and decodes the video using a media player.

The terminal records viewing status information, operation history information, and reaction information. For instance, the terminal records whether the video playback reached the end, the total playback duration, any pause or skip operations, and any user reactions such as likes or comments. The terminal packages these records as structured data and transmits them back to the server.

The server receives the feedback information and stores it in a user engagement table. The server computes engagement metrics for different types of content and for different prompt sentence settings. The server updates the user profile by adjusting interest category weights and behavioral characteristic values based on observed engagement. The server also updates generation conditions for future prompt sentences by changing target length, tone, or level of detail. For instance, if the server observes that the user consistently stops watching long videos, the server will reduce the target length in subsequent prompt sentences.

This feedback-driven control loop produces technical effects on the system. Because the server continuously refines the user profile and the generation conditions on the basis of measured interaction, the server can generate more suitable prompt sentences and thereby reduce the need for repeated calls to the generative AI models. This reduces computational load and network traffic. By structuring generated text into scenes and visual element information, the server avoids regenerating full scripts when only certain scenes are ineffective, and can instead modify specific segments. This modular approach simplifies content updates and improves computation efficiency.

The server uses non-conventional data structures and workflows that differ from merely automating human editorial work. In a human-driven process, an editor would manually write a script, select images, and assemble a video for each user or segment. In contrast, the server uses a combination of profile vectors, structured content data, and time-indexed storyboards that allow automated optimization at a granularity not practical for human editors. The server also uses a generative AI model as a controlled component whose behavior is modulated by dynamically computed prompt sentences, instead of manually crafted instructions.

The server uses specific learning methods to train the classifiers and emotion analysis models.

In one embodiment, the server trains a neural network-based emotion classifier on labeled text samples with a loss function such as cross-entropy. The server updates model weights by stochastic gradient descent or a variant thereof, such as Adam, and uses data augmentation techniques to increase training set diversity. For example, the server may replace synonyms or reorder phrases in training texts while preserving labels. Similarly, the server may pretrain an interest classifier on large corpora and then fine-tune the classifier on the specific behavioral data collected by the system.

The server implements its data flow as a pipeline of modules. A collection module receives data from terminals and external services. A preprocessing module normalizes time stamps and encodes categorical values. An analysis module computes profile vectors and emotion states. A prompt generation module constructs prompt sentences for the generative AI models. A content structuring module converts text information to structured content data. A visual generation module communicates with an image-generation generative AI model. A rendering module uses the video generation program to output video files. A notification module sends notification data. A feedback module processes engagement logs and updates the profile and generation conditions. Each module exposes an interface and passes well-defined data structures to the next module, so that the entire pipeline operates deterministically and can be implemented on general-purpose hardware.

In another embodiment, the server may use different generative AI models for different languages or for different content types. The server may select a model variant with fewer parameters for low-latency applications, and a larger model for high-quality generation when latency is less critical. The server may also cache commonly used content segments for reuse.

In another embodiment, the server may adjust the frame rate, resolution, or compression parameters of the video file based on network conditions or terminal capabilities. For example, the server may store, in the user profile, flags indicating the terminal's display resolution and historical network bandwidth. The server may then instruct the video generation program to render multiple video versions and to select an appropriate version for each terminal, thereby reducing transmission time and improving user experience.

In another variation, the server may generate only still images and text overlays instead of full motion video when network resources are constrained. In this case, the storyboard structure remains applicable, and the server controls presentation timing at the terminal.

These embodiments demonstrate that the system provides more than an abstract idea of content recommendation. The server uses specific data structures, learning algorithms, and control logic to improve how a computer stores and uses user profiles, how it generates and structures prompt sentences for generative AI models, and how it orchestrates content rendering and delivery. By aligning model selection, prompt sentence construction, structured content representation, and storyboard configuration with engagement-based feedback, the system reduces unnecessary processing, improves accuracy of personalization, and achieves better utilization of computational and communication resources.

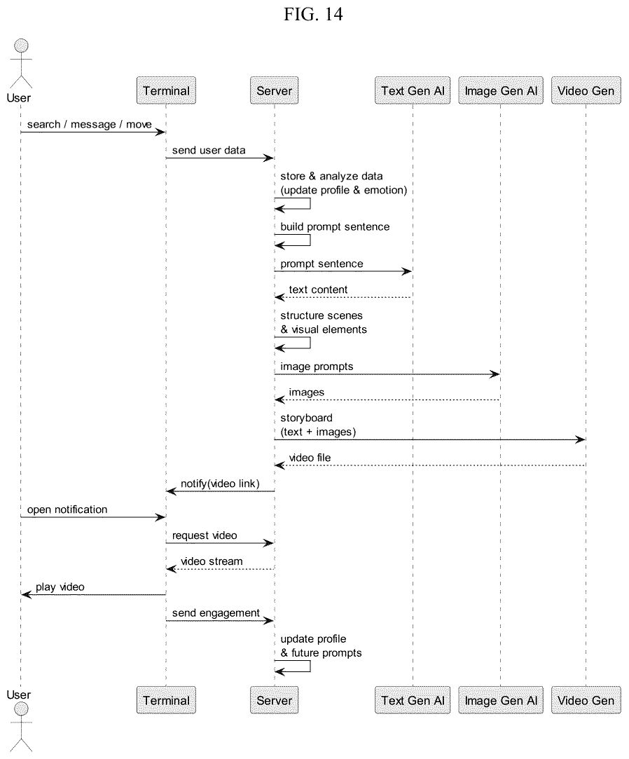

The following describes the processing flow using FIG. 14.

### Step 1:

The user generates activity and input data.

The user performs searches, sends messages, uses applications, moves with a terminal, and optionally enters text or speaks into the terminal.

Input: No structured input; this step generates raw user actions.

Output: Raw interaction events observable by the terminal, such as keystrokes, application usage events, geolocation changes, and microphone signals.

### Step 2:

The terminal acquires and structures user behavioral information and user input information.

The terminal reads search history, communication history, and application usage logs from an operating system interface; the terminal acquires location information from a position sensor; the terminal acquires text input from application input fields and audio data from a microphone.

Input: Raw interaction events from the user and low-level sensor readings (e.g., GPS coordinates, audio samples).

Output: Structured data records containing a user identifier, a timestamp, a data type, and a payload (e.g., text string, URL list, coordinate sequence, audio byte stream).

The terminal converts continuous sensor signals and event streams into discrete records by sampling, time-stamping, and classifying each piece of data into predefined types.

### Step 3:

The terminal transmits structured user data to the server.

The terminal packages multiple structured data records into a request body and sends the request to a server endpoint over a secure connection.

Input: Structured data records generated in Step 2.

Output: Network messages containing serialized structured data delivered to the server.

The terminal adds authentication tokens and encrypts the payload, then uses a request-response protocol to ensure successful delivery.

### Step 4:

The server receives and stores the user data.

The server accepts network messages from the terminal, validates the message format and authentication information, and parses the serialized payload into internal objects.

Input: Network messages containing structured user data records.

Output: Database entries in tables or collections for search logs, communication logs, location logs, and emotion-related inputs.

The server performs data validation, converts timestamps to a unified time zone, normalizes identifiers, and inserts records into persistent storage, thereby transforming network-level messages into indexed database rows or documents.

### Step 5:

The server aggregates stored data into a user profile feature set.

The server queries the database for recent records associated with a user identifier and aggregates these records over a configurable time window.

Input: Database records of behavioral logs and input logs for a given user.

Output: Intermediate feature sets including text corpora, numeric usage statistics, and location visit sequences.

The server groups records by type, concatenates text fields, computes counts and frequencies, and compiles location trajectories, thereby transforming many small records into coherent data sets suitable for analysis.

### Step 6:

The server analyzes interest categories using natural language processing and machine learning.

The server tokenizes and parses text corpora (e.g., messages, queries) and extracts terms and entities; the server applies a trained classifier to infer topic labels and interest categories.

Input: Text corpora and usage statistics from Step 5.

Output: One or more interest category identifiers and associated confidence scores.

The server converts text into token indices, computes embeddings, feeds the embeddings into a neural network classifier, and evaluates softmax outputs to assign categories such as outdoor, entertainment, or finance, thereby converting unstructured text into categorical interest information.

### Step 7:

The server computes behavioral characteristics.

The server constructs a feature vector representing user behavior, including counts of actions per category, time-of-day distributions, and recency measures.

Input: Aggregated usage statistics and timestamps from Step 5.

Output: A behavioral characteristic vector for the user.

The server applies mathematical operations such as counting, averaging, exponential decay weighting, and normalization, and may apply clustering or dimensionality reduction, thereby transforming raw counts into a compact numerical representation of behavior.

### Step 8:

The server estimates the emotional state of the user.

The server runs an emotion analysis algorithm on recent text inputs and on text obtained from audio inputs; the server converts audio to text using a speech-to-text model and then processes the text with a sentiment classifier.

Input: Emotion-related text and audio records from Step 4.

Output: An emotional state vector and a discrete emotional label (e.g., joy, sadness).

The server computes token embeddings, passes them through an emotion classifier network, obtains emotion probabilities, and applies a decision rule (e.g., argmax) to select a label, thereby converting heterogeneous signals into a quantitative emotional representation.

### Step 9:

The server updates and stores the user profile.

The server combines interest categories, behavioral characteristics, and the emotional state into a unified profile data structure and writes or updates this structure in the profile store.

Input: Interest category data from Step 6, behavioral characteristic vector from Step 7, and emotional state from Step 8.

Output: A persisted user profile object with updated fields.

The server merges new feature values with existing profile values, applies weighting for recency, and serializes the profile into a format suitable for database storage, thereby maintaining a current representation of user context.

### Step 10:

The server determines the content generation purpose and control parameters.

The server reads the user profile and business rules to decide whether to generate explanatory content, advertising content, or emotion-support content, and computes control parameters such as target length, tone, and detail level.

Input: User profile from Step 9 and rule configurations stored in the server.

Output: A set of content control parameters including content type, output format, writing style, length, and usage purpose.

The server uses conditional logic based on interest strength, emotional state, and past engagement metrics to select parameter values, thereby converting profile data into explicit control settings for content generation.

### Step 11:

The server generates a prompt sentence for a text-type generative AI model.

The server constructs a natural language instruction by embedding the control parameters and user context into a prompt template.

Input: Content control parameters from Step 10 and fields from the user profile.

Output: A prompt sentence that will be supplied to a generative AI model.

The server concatenates fixed template phrases with variable segments representing interest categories and emotional state, and ensures that the instruction specifies output format, tone, and length, thereby turning structured settings into a descriptive text command.

### Step 12:

The server calls the text-type generative AI model with the prompt sentence.

The server encodes the prompt sentence into tokens, sends the token sequence to the generative AI model, and configures generation parameters such as maximum tokens and temperature.

Input: Prompt sentence generated in Step 11.

Output: Generated text information in the form of a token sequence representing content such as a script or explanation.

The server performs tokenization, network transmission to the model host, receives token probability distributions frame by frame, and applies decoding (sampling or beam search) to reconstruct human-readable text, thereby transforming the prompt sentence into content text.

### Step 13:

The server converts the generated text into structured content data.

The server segments the text into logical units such as scenes, identifies explanatory sentences, and extracts references to visual elements such as objects and locations.

Input: Text information from Step 12.

Output: Structured content data including scene information, explanatory information, and visual element information.

The server scans for sentence boundaries, uses part-of-speech tagging and entity recognition to detect visual elements, and assigns identifiers and attributes to each scene, thereby mapping free-form text into a structured representation suitable for subsequent visual generation.

### Step 14:

The server generates prompt sentences for an image-generation generative AI model.

The server, for each scene, composes a description that combines visual element information with style requirements and usage context.

Input: Visual element information and scene information from Step 13, and style parameters derived from content control parameters.

Output: One or more prompt sentences for image generation, each associated with a scene identifier.

The server concatenates visual descriptors, style indicators (e.g., photorealistic, minimal illustration), and context instructions (e.g., suitable for advertisement) into textual prompts, thereby encoding structured visual requirements into natural language commands.

### Step 15:

The server calls the image-generation generative AI model and obtains image data.

The server submits each image prompt sentence to the image-generation model, configures resolution and sampling parameters, and receives corresponding image outputs.

Input: Image prompt sentences from Step 14.

Output: Image data objects or references for each scene.

The server executes a diffusion or similar image synthesis process on general-purpose hardware or a graphics processor, receives pixel matrices or encoded image files, and stores them in an image repository, thereby transforming textual descriptions into visual assets.

### Step 16:

The server constructs a storyboard for short-duration visual content.

The server decides the number of scenes, the order of scenes, and the duration of each scene, taking into account the user's behavioral characteristics and emotional state.

Input: Structured content data from Step 13, image references from Step 15, and behavioral/emotional vectors from the user profile in Step 9.

Output: A storyboard data structure associating each scene with an image reference, explanatory text, and timing information.

The server computes scene timing by applying rules or optimization criteria (e.g., total duration constraint, minimum readable time per caption), sequences scenes to maximize relevance, and assigns start and end times, thereby converting content and images into a time-indexed presentation plan.

### Step 17:

The server renders the storyboard into a video file using a video generation program.

The server provides the storyboard to the video generation program, which loads images, overlays text captions, applies transitions, and encodes frames into a compressed video stream.

Input: Storyboard from Step 16.

Output: A video file with a predetermined duration and a unique identifier or location.

The server orchestrates the rendering pipeline by invoking encoding libraries, specifying frame rate and resolution, and writing the resulting bitstream to storage, thereby transforming storyboard instructions into a playable media file.

### Step 18:

The server registers the video file and prepares notification data.

The server stores the video file in a content storage component, generates identification information and reference location information, and constructs a summary title and description.

Input: Video file from Step 17 and metadata such as user identifier and content type.

Output: Notification data containing identification information, reference location information, and summary text.

The server writes content records in a catalog, generates human-readable titles from text information, and packages all values into a notification payload structure, thereby converting internal content identifiers into externally usable notification data.

### Step 19:

The server sends notification data to the terminal.

The server uses a communication application interface or an information providing application interface to transmit the notification payload to the terminal as a push message or in-app message.

Input: Notification data from Step 18 and terminal addressing information.

Output: A delivered notification message at the terminal side.

The server chooses an appropriate channel, formats the payload according to the channel's protocol, and invokes network APIs to push the message, thereby transforming internal data into user-visible alerts.

### Step 20:

The terminal displays the notification and plays the video.

The terminal receives the notification message, shows a title and summary on the display, and, when the user selects the notification, retrieves and plays the video file.

Input: Notification message from Step 19 and video reference location information.

Output: A playback session showing the short-duration video on the terminal screen.

The terminal requests the video via a network, buffers and decodes the video stream, synchronizes audio and visual frames if present, and renders frames on the display, thereby converting remote stored media into local user experience.

### Step 21:

The terminal logs viewing status, operation history, and reaction information.

The terminal monitors video playback events, such as start, pause, seek, end, and user interactions such as clicks or reactions.

Input: User actions during playback and internal player state changes.

Output: Engagement records containing timestamps, event types, and related identifiers.

The terminal records each event as a data structure and aggregates events per session, thereby transforming transient user interactions into persistent engagement data.

### Step 22:

The terminal transmits engagement records to the server.

The terminal sends the engagement data to the server as structured messages, similar to the upload of behavioral data.

Input: Engagement records from Step 21.

Output: Network messages containing engagement information delivered to the server.

The terminal packages multiple records, adds identifiers, and uses a secure protocol to upload them, thereby moving client-side feedback to the server side.

### Step 23:

The server processes engagement information and updates the user profile and future prompt conditions.

The server receives engagement messages, stores them in an engagement table, computes engagement metrics such as completion rate and click-through rate, and adjusts interest weights and content control parameters accordingly.

Input: Engagement messages from Step 22 and existing profile and log data.

Output: Updated user profile entries and updated generation conditions for future prompt sentences.

The server performs statistical calculations on engagement data, correlates performance with previous prompt sentence structures, and modifies parameters such as target length, tone, or emphasis; this transforms feedback into concrete adjustments of future generative AI model control, closing the loop and improving personalization and efficiency.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

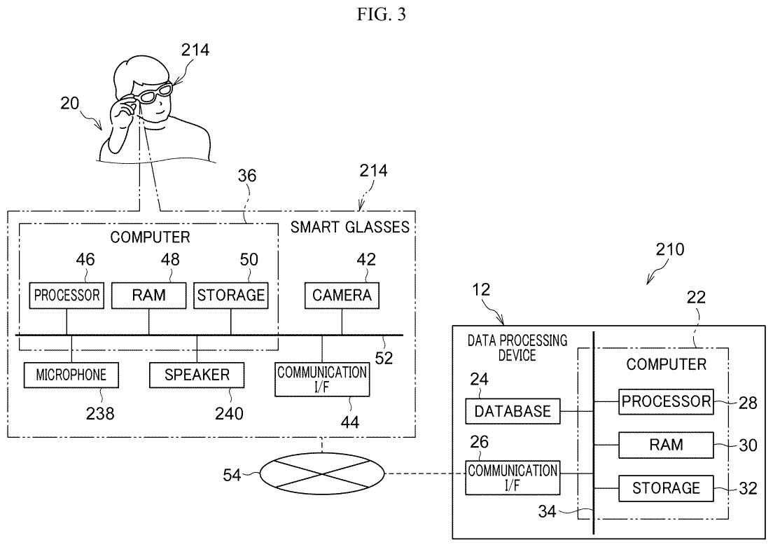

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

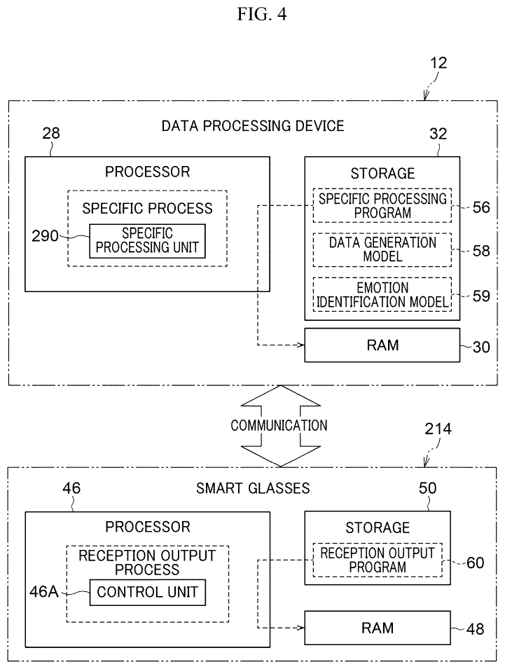

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

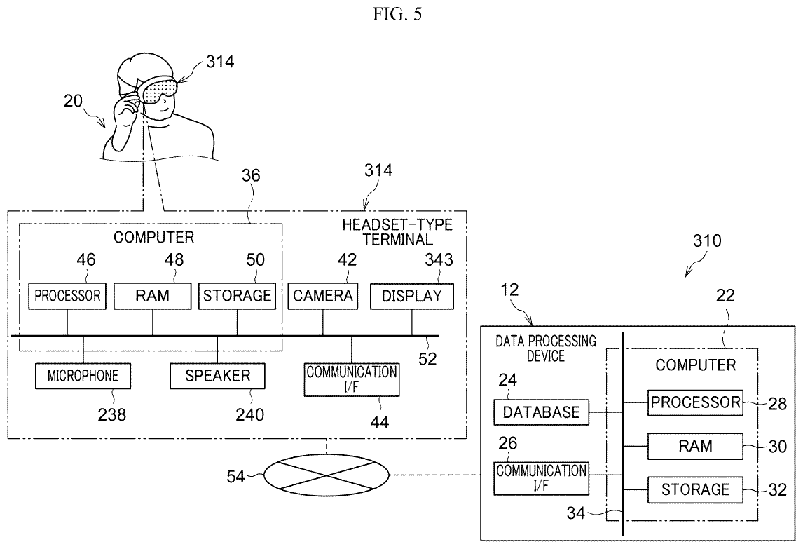

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

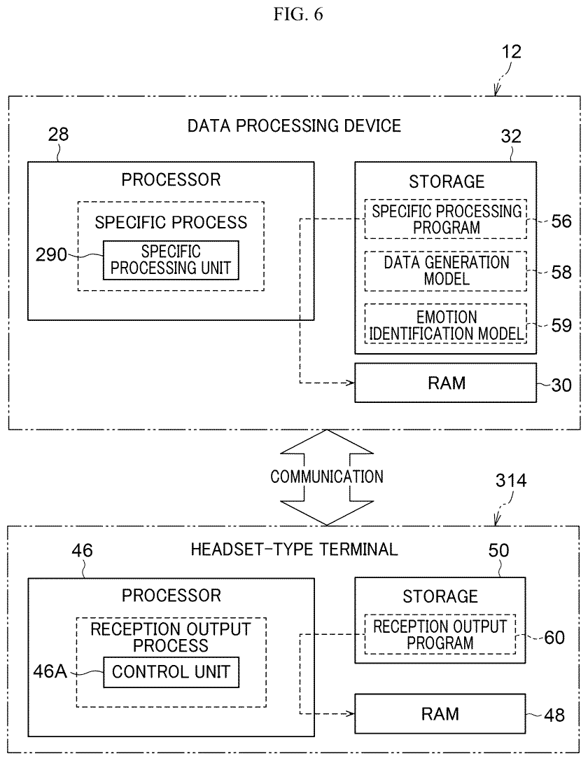

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

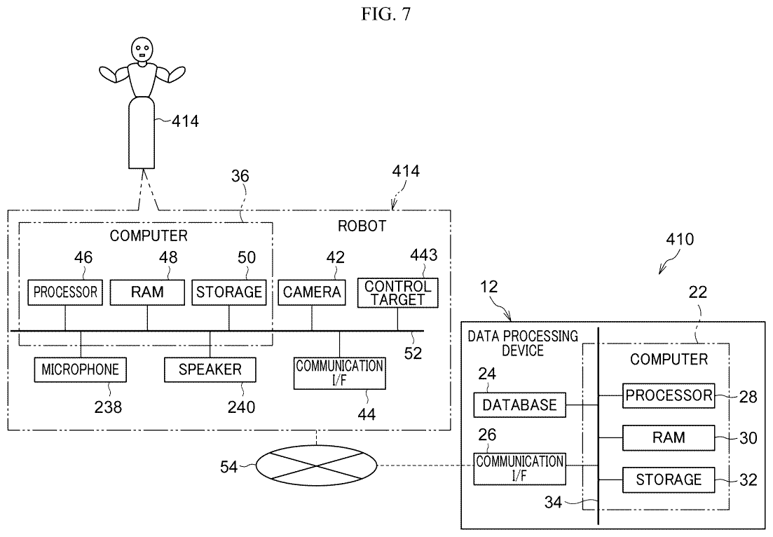

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

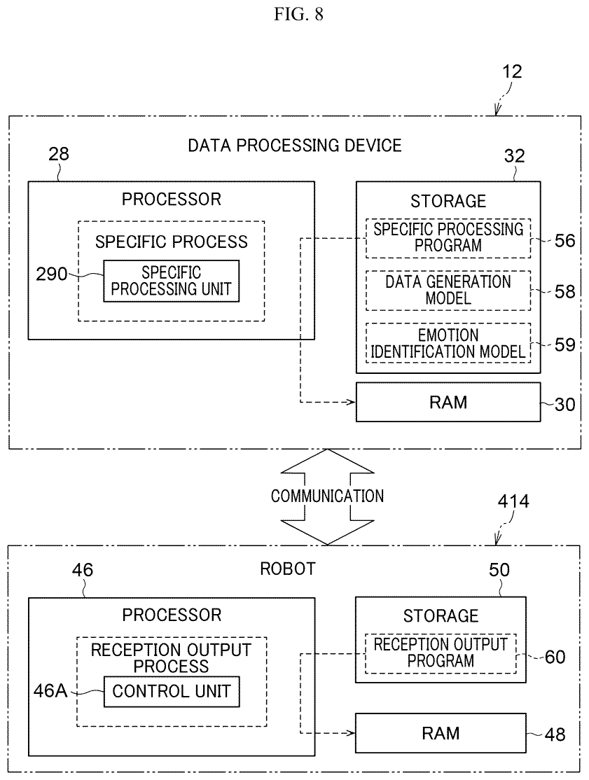

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

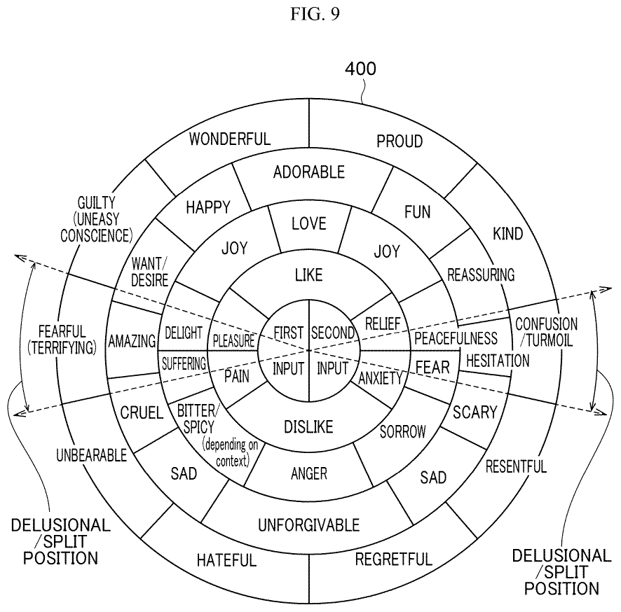

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

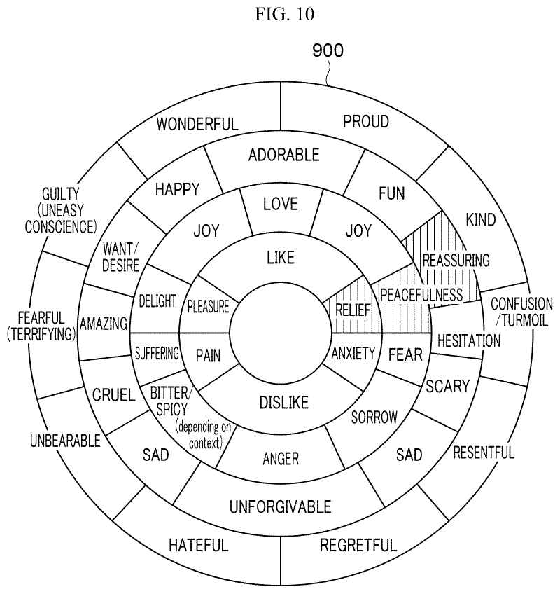

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure.

This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, by using a sensor device or a software module, online activity information and location information of a user,
analyze the acquired information to extract feature data representing preferences and interests of the user, and generate a user profile based on the feature data,
construct, based on the user profile, a first prompt sentence as text input for a generative AI model, input the first prompt sentence to the generative AI model, and obtain, from the generative AI model, personalized information in a text format,
divide the personalized information into a plurality of scene units, generate a video scenario including visual content information and subtitle information corresponding to each of the plurality of scene units, and generate, based on the video scenario, a second prompt sentence for video generation,
input the second prompt sentence as text input to a text-to-video type generative AI model and automatically generate short video data,
store the generated short video data in an external storage device, and transmit, via a communication network to a terminal device, notification data including identification information for accessing the short video data, and
acquire viewing history information and feedback information relating to the short video data from the terminal device, store the viewing history information and the feedback information in association with the user profile, and update generation conditions of the first prompt sentence and the second prompt sentence based on a result of the storing.

### (Supplementary 2)

The system according to supplementary 1,
wherein the processor is configured to dynamically change, based on the viewing history information and the feedback information, instruction content in the first prompt sentence regarding weighting of interest fields and a presentation format, and repeatedly generate the personalized information by using the changed first prompt sentence as input to the generative AI model.

### (Supplementary 3)

The system according to supplementary 1,
wherein the processor is configured to add, for each of the plurality of scene units in the video scenario, at least one control parameter including a video length, an aspect ratio, an
expression style, and display text to the second prompt sentence, and provide the generated short video data to the terminal device via an application programming interface of a communication application or an information search tool in accordance with the control parameter.

### Application Example 1

### (Supplementary 1)

A system comprising a processor,
wherein the processor is configured to
acquire user operation history information and location information by using a sensor apparatus or an information acquisition program unit in a computing apparatus that operates in communication with an information processing apparatus, and store the acquired information in a storage device,
read the user operation history information and the location information stored in the storage device, split and normalize the operation history information by a character string processing function, convert the operation history information into numerical feature values by a feature value calculation function, convert the location information into regional attributes by a geographic information association function, and input the numerical feature values and the regional attributes to a machine learning model to calculate a classification result relating to a user interest or preference and interest degree information based on the classification result, generate an information provision plan including a length of video information, a scene configuration, explanation content, tone, and appeal content on the basis of the classification result and the interest degree information, and automatically generate a prompt sentence to be input to a generative artificial intelligence model in accordance with the information provision plan,
obtain text information from the generative artificial intelligence model, divide the text information on a per-scene basis, generate audio data for each scene by using a speech synthesis function, obtain visual data for each scene by using an image generation function or an image retrieval function, and record the audio data and the visual data as configuration information associated with time information,
generate video data having a predetermined time length by using a video composition processing program on the basis of the configuration information by arranging the visual data, the audio data, and subtitle text information on a time axis, and register the generated video data in the storage device or an external storage service,
generate notification information including identification information and description information associated with the video data, and transmit the video data or reference information to the video data to a user terminal by using a communication function of a communication application or an information retrieval program, and
receive usage record information from the user terminal, the usage record information indicating a playback state, an operation state, or reaction information relating to the video data, and reuse the usage record information as input or learning information for the machine learning model to update the classification result and processing for generation of the prompt sentence.

### (Supplementary 2)

The system according to supplementary 1,
wherein the processor is configured to automatically generate the prompt sentence to be input to the generative artificial intelligence model from structured information including the classification result relating to the user interest or preference, an information provision theme selected on the basis of the classification result, a video time length, a number of scenes, explanation content for each scene, and a constraint indicating presence or absence of a call-to-action phrase, and obtain from the generative artificial intelligence model the text information including explanation text for each scene, a script for audio, and character strings for subtitles.

### (Supplementary 3)

The system according to supplementary 1,
wherein the processor is configured to control the video composition processing program to perform processing for displaying a plurality of images or video segments for predetermined times, processing for adding transition effects between scenes, processing for arranging the audio data on the time axis, and processing for superimposed display of the subtitle character strings, to collectively generate the video data having the predetermined time length on the basis of the configuration information, and to distribute reference information to the video data to the user terminal via a notification function of the communication application or the information retrieval program.

### Example 2

### (Supplementary 1)

A system comprising a processor,
wherein the processor is configured to
acquire behavior history information and location information relating to a user from an external information processing apparatus or an external information providing apparatus by using a communication function, and to generate a behavior data set by integrating the behavior history information and the location information,
to apply a character information processing algorithm and a feature extraction algorithm to the behavior data set so as to calculate feature quantities indicating a field of interest of the user and a behavior tendency of the user, and to generate user profile data on the basis of the feature quantities,
to construct a prompt sentence including a generation instruction text, user context information, and constraint conditions, by using the user profile data and predetermined template information, and to generate the prompt sentence,
to input the prompt sentence into a generative model having a natural language processing function, to obtain generated information including an explanatory text or a commentary text customized for each user as an output of the generative model, and to store the generated information in association with a recording resource,
to divide the generated information into a plurality of scene information elements and subtitle information elements, to select or generate image information or video clip information corresponding to the scene information elements, to generate audio data based on the generated information by using a speech synthesis function, and to automatically generate short-duration video content data by performing editing processing that synchronizes the image information or the video clip information, the subtitle information elements, and the audio data on a time axis,
to store the short-duration video content data in a storage device, to generate access identification information for accessing the short-duration video content data, and to transmit the access identification information or the short-duration video content data itself to a user terminal through an interface of a notification service or a communication application having a communication function, and
to acquire viewing history information or reaction information relating to the short-duration video content data from the user terminal, and to add the viewing history information or the reaction information to the behavior data set and reflect the viewing history information or the reaction information again in the feature extraction algorithm and in construction processing of the prompt sentence, thereby dynamically updating a subsequent prompt sentence and subsequent generated information.

### (Supplementary 2)

The system according to supplementary 1,
wherein the processor is configured to automatically modify the prompt sentence to be input to the generative model on the basis of weighting information for types of the field of interest of the user and on the basis of the viewing history information relating to previously generated short-duration video content data, and to control a priority of topics and a length of the explanatory text or the commentary text to be generated.

### (Supplementary 3)

The system according to supplementary 1,
wherein the processor is configured, in generating the short-duration video content data, to divide the generated information into units for each scene, to determine background video and a text display position for each scene unit by using an image generation function or a video editing function, and to automatically adjust subtitle display timing and scene switching timing on the basis of time information of the audio data generated by the speech synthesis function.

### Application Example 2

### (Supplementary 1)

A system comprising a processor,
wherein the processor is configured to
collect user behavioral information and user input information by using an information acquisition device or an information acquisition program to acquire, via a network, at least search history, communication history, location information, and text data or audio data serving as a target for emotion estimation,
process the collected information by an information analysis algorithm to identify, on the basis of natural language processing and machine learning, an interest category and a behavioral characteristic of a user, analyze the collected information by an emotion analysis algorithm to estimate an emotional state of the user, and generate a user profile including the interest category, the behavioral characteristic, and the emotional state,
generate, on the basis of the user profile, a prompt sentence including constraint conditions defining an output format, a writing style, a length, and a usage purpose, and configure the prompt sentence as a prompt sentence to be input to a generative AI model,
obtain text information output from the generative AI model in response to the prompt sentence and edit the text information into structured content data by dividing the text information into scene information, explanatory information, and visual element information, generate, on the basis of the structured content data, a prompt sentence including the visual element information for an image-generation generative AI model, input the prompt sentence to the image-generation generative AI model, and obtain image data output from the image-generation generative AI model,
generate, on the basis of the text information and the image data, a storyboard of short-duration visual content by associating the text information and the image data with time information, and automatically generate a video file having a predetermined duration by using a video generation program,
generate notification data including identification information and reference location information of the generated video file, and transmit the notification data to a user terminal via a communication interface for using a notification function of a communication application or an information providing application, and
obtain viewing status information, operation history information, and reaction information of the video transmitted from the user terminal, and update the user profile and generation conditions of a future prompt sentence on the basis of an obtained result.

### (Supplementary 2)

The system according to supplementary 1,
wherein the processor is configured to
control the prompt sentence such that the text information includes explanatory content and advertising content that are generated separately according to the interest category and the emotional state of the user, and obtain, from the generative AI model, the explanatory content and the advertising content as respective types of text information.

### (Supplementary 3)

The system according to supplementary 1,
wherein the processor is configured to
determine, in generating the storyboard, a number of scenes, a display time of each scene, and a display order of the scenes according to the interest category and the emotional state included in the user profile, and input determination results to the video generation program so as to automatically generate a short-duration video having a configuration that differs for each user.

What is claimed is:

1. A system comprising:
circuitry configured to:
receive, via a communication interface coupled to a packet-switched network, sensor data acquired by a sensor device or a software module of a terminal device;
process the sensor data using a data analysis algorithm to identify a classification label representing an interest or a concern associated with the sensor data; and
generate, based on the classification label, a natural-language prompt sentence and supply the natural-language prompt sentence to a transformer-based generative neural network model to acquire inference output data adapted to the classification label.

2. The system according to claim 1, wherein the circuitry is further configured to:
transmit the inference output data, via the communication interface coupled to the packet-switched network, to the terminal device for rendering on a display of the terminal device.

3. The system according to claim 2, wherein the sensor data comprises at least one of behavior history information acquired by a software module monitoring application usage patterns, location information acquired by a positioning sensor, and interaction event data acquired by an input device of the terminal device.

4. The system according to claim 3, wherein processing the sensor data comprises:
normalizing the sensor data into a unified schema comprising fields for a user identifier, a timestamp, a content type, and content text;
applying a natural language processing algorithm to the content text to perform tokenization, stop-word removal, and language detection; and
computing feature quantities from the normalized sensor data using at least one of a term-frequency inverse-document-frequency scheme and a neural encoder that generates embedding vectors.

5. The system according to claim 4, wherein identifying the classification label comprises:
applying a clustering algorithm to the feature quantities to group frequently occurring terms into fields of interest; and
aggregating the feature quantities into a user profile comprising a distribution over content topics, a temporal activity histogram, and an engagement score for each content category.

6. The system according to claim 5, wherein the circuitry is further configured to:
store the user profile in a non-transitory storage medium and incrementally update the user profile when new sensor data is received.

7. The system according to claim 6, wherein generating the natural-language prompt sentence comprises:
selecting a prompt template from a template repository stored in the non-transitory storage medium;
retrieving the user profile and inserting at least top fields of interest, a recent behavior summary, and a preferred content length into placeholders of the prompt template to form the natural-language prompt sentence.

8. The system according to claim 7, wherein the transformer-based generative neural network model processes the natural-language prompt sentence through a plurality of self-attention layers and feed-forward layers and generates the inference output data as personalized information content adapted to the fields of interest indicated in the user profile.

9. The system according to claim 1, wherein the circuitry is further configured to:
apply an emotion estimation neural network classifier to at least one of text data and audio data received from the terminal device to compute a dominant emotion category; and
adjust content of the natural-language prompt sentence based on the dominant emotion category to influence a tone or emphasis of the inference output data.

10. The system according to claim 9, wherein the emotion estimation neural network classifier receives at least one of word embeddings, mel-frequency cepstral coefficient features, and facial landmark coordinate features and outputs a probability distribution over emotion categories via a softmax output layer.

11. The system according to claim 1, wherein the circuitry is further configured to:
generate, based on the inference output data, a video generation instruction set; and
invoke a video processing module to automatically produce a short-duration video from the video generation instruction set and transmit the short-duration video to the terminal device via the communication interface.

12. The system according to claim 11, wherein the video generation instruction set comprises scene descriptions, text overlay content, transition parameters, and duration parameters derived from the inference output data.

13. The system according to claim 12, wherein the circuitry is further configured to:
transmit the short-duration video to the terminal device via an application programming interface of a communication application installed on the terminal device.

14. The system according to claim 1, wherein the circuitry is further configured to:
receive, from the terminal device via the communication interface, feedback data indicating a user response to the inference output data; and
update at least one of the classification label and parameters of the data analysis algorithm based on the feedback data to improve subsequent identification of interests or concerns.

15. The system according to claim 14, wherein updating comprises:
computing a reward signal from the feedback data and applying a reinforcement learning update to weighting parameters of the data analysis algorithm.

16. The system according to claim 15, wherein the circuitry is further configured to:
apply a dimensionality reduction algorithm to the embedding vectors to derive compact feature quantities that represent user preference tendencies; and
store the compact feature quantities in the non-transitory storage medium for use in subsequent prompt sentence generation.

17. The system according to claim 16, wherein the inference output data comprises personalized information content including at least one of a news article summary, a product recommendation, a health tip, and an event notification, each adapted to the classification label and the user profile.

18. A system comprising:
circuitry configured to:
receive, via a communication interface coupled to a packet-switched network conforming to at least one of a 5G, Wi-Fi, or Bluetooth communication standard, sensor data from a terminal device, the sensor data comprising at least one of behavior history information, location information, and interaction event data;
normalize the sensor data into a unified schema and apply a natural language processing algorithm to perform tokenization and language detection;
compute feature quantities using at least one of a term-frequency inverse-document-frequency scheme and a neural encoder generating embedding vectors, and apply a clustering algorithm to identify fields of interest;
aggregate the feature quantities into a user profile comprising a distribution over content topics and an engagement score for each content category;
generate a natural-language prompt sentence by inserting the user profile data into a prompt template;
apply an emotion estimation neural network classifier to data received from the terminal device to compute a dominant emotion category and adjust the natural-language prompt sentence based on the dominant emotion category;
supply the natural-language prompt sentence to a transformer-based generative neural network model comprising a stack of self-attention layers and feed-forward layers and acquire inference output data comprising personalized information content;
generate a video generation instruction set from the inference output data and invoke a video processing module to produce a short-duration video; and
transmit, via the communication interface coupled to the packet-switched network, the inference output data and the short-duration video to the terminal device for rendering on a display of the terminal device.

19. The system according to claim 18, wherein the circuitry is further configured to:
receive feedback data from the terminal device indicating a user response to the inference output data and update parameters of the data analysis algorithm based on the feedback data using a reinforcement learning update.

20. A method comprising:
receiving, by circuitry via a communication interface coupled to a packet-switched network, sensor data acquired by a sensor device or a software module of a terminal device;
processing, by the circuitry, the sensor data using a data analysis algorithm to identify a classification label representing an interest or a concern associated with the sensor data; and
generating, by the circuitry, based on the classification label, a natural-language prompt sentence and supplying the natural-language prompt sentence to a transformer-based generative neural network model to acquire inference output data adapted to the classification label.
